(19) United States
(12) Patent Application Publication
(10) Pub. No.: US 2007/0229268 A1
(43) Pub. Date: Oct. 4, 2007

(54) VEHICLE INSPECTION USING RADIO FREQUENCY IDENTIFICATION (RFID)

(75) Inventors: Michael D. Swan, Lake Elmo, MN (US); Diane E. Morel, Shoreview, MN (US); Sherman L. Bartz, Saint Paul, MN (US); Donald L. Melvin, Stillwater, MN (US); Joel S. Graf, Vadnais Heights, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/694,267

(22) Filed: Mar. 30, 2007

Related U.S. Application Data
(60) Provisional application No. 60/889,105, filed on Feb. 9, 2007.
(60) Provisional application No. 60/863,821, filed on Nov. 1, 2006.
(60) Provisional application No. 60/744,184, filed on Apr. 3, 2006.

(51) Int. Cl. G08B 13/14; G06F 17/00

(52) U.S. Cl. 340/572.1; 235/375

(57) ABSTRACT

In general, the invention is directed to methods and articles for inspecting aircraft life vests using radio frequency identification technology (RFID). In various embodiments, methods of inspecting an aircraft for life vests are described.

This application claims the benefit of U.S. Provisional Application No. 60/889105, filed Feb. 9, 2007, and U.S. Provisional Application No. 60/863821, filed Nov. 1, 2006, and U.S. Provisional Application No. 60/744184, filed Apr. 3, 2006, the disclosure of which is incorporated by reference herein in its entirety.

### TECHNICAL FIELD

The invention generally relates to tracking and managing life vests on aircraft, and more specifically to methods of life vest inspection and systems to support the methods of inspection.

### BACKGROUND

Aircraft that fly a certain distance over water are often required to have a life vest for every person on board that aircraft. To ensure the presence of each required life vest, at least two types of inspection are often conducted. The first is a pre-flight inspection, which is typically made by the flight attendant or gate mechanic. This pre-flight inspection confirms the presence of life vests under each aircraft seat or where life vests are otherwise required. If any given life vest is missing, the life vest is replaced or the seat is not used on the flight. The second is a more comprehensive inspection, which is made by mechanics as part of routine maintenance. In this type of inspection, the mechanics or other authorized personnel not only inspect the life vests for their presence but also their expiration dates.

Most aircraft life vest inspections are done manually, by a person or persons visually confirming the presence of a life vest where one is required, then, if necessary, manipulating the life vest to ascertain information concerning the life vest, such as to check the expiration date or other information. This information is often printed upon labels, the life vest itself, or the life vest's packaging.

### SUMMARY

In general, the invention is directed to methods and articles for inspecting aircraft life vests using radio frequency identification technology (RFID). As one example, computer-implemented RFID-enabled inspection devices (for example computers or personal digital assistants with RFID functionality) are described that provide graphical user interfaces to assist in facilitating the inspection. In a further example, the graphical user interface renders a representation of a portion of the aircraft, associating visual indicia with areas on the aircraft where life vests are expected to be located.

As another example, methods are described whereby an employee of an airline, or another individual charged with inspecting an aircraft's life vests, loads information concerning the aircraft into his or her inspection device. The inspector then proceeds to move within the aircraft and interrogate RFID tags located upon life vests or life vest packaging, and possibly RFID tags that provide proximity information. In some embodiments, the proximity information is derived from the stream of life vest RFID tag information captured during the interrogation such that no proximity RFID tags are necessary.

This captured information is compared to the information concerning the aircraft, and the device identifies any exception conditions that may be present. For example, an exception condition may exist when the inspection device does not receive indication of one or more RFID tags where a database or other data store indicates that an RFID-tagged life vest should be located. Additionally, an exception condition may exist when the inspection device receives information indicating one or more life vests are expired, soon-to-be expired, or misplaced. The inspector may then remedy the exception conditions as they arise, or alternatively the data defining the exception conditions may be used to generate an exception report which can be used at a later time to remedy any exceptions.

The RFID-enabled inspection device may contain an output, e.g., a display screen, which provides information to the inspector. This information may include visual representations of the aircraft (or portions of the aircraft), the locations where life vests are expected, and the presence or absence of the life vests. The information may be graphically presented and arranged in a manner that facilitates and supports the inspector's movement within the aircraft during an inspection.

In certain embodiments, RFID tags may be located upon, within, or within close proximity to the life vests (upon life vest packaging, for example). These tags may be located inside of the life vest. Interior placement allows for increased protection for the RFID tag against tampering and removal. Particularly, placement of an RFID tag on an interior surface of the life vest protects the tag from environmental risks (such as impact, abrasion, picking, chemical attack, or oxidative degradation).

In another embodiment, the tags may be manufactured and affixed to the life vest or a package containing the life vest so as to function differently if an individual tampers with the life vest, the package, or the RFID tag itself. For example, the RFID tag may be oriented on a package containing a life vest such that upon opening the package, at least a portion of the RFID tag is compromised, which renders the RFID tag to function differently than had the compromise not occurred. In one embodiment, the RFID tag ceases to function entirely upon compromise. Alternatively, the RFID tag supplies certain data upon interrogation to report the tampering.

A variety of approaches to placing an RFID tag on the interior of a life vest are described. Examples include having a non-adhered, non-secured RFID tag inside the life vest that can freely move within the life vest or device. Alternatively, adhesives are described that work well on the interior surfaces of life vests. Finally, non-adhesive based methods of securing the RFID tag to the interior of a life vest are described. These include, for example, the use of ultrasonic welding.

In one embodiment, the invention is directed to a method comprising storing, within a handheld radio frequency identification (RFID) inspection device, an aircraft profile that at least identifies expected locations of one or more life vests on an aircraft; interrogating, with the handheld RFID inspection device, at least one RFID tag associated with a life vest on an aircraft; and, reading, into the handheld RFID inspection device, RFID tag information from the interrogated RFID tag.

In another embodiment, the invention is directed to a method comprising storing, with a handheld radio frequency identification (RFID) inspection device, an aircraft profile that includes a unique identifier for a plurality of life vests expected to be on an aircraft, wherein the aircraft profile further includes location identification data that defines expected locations of at least some of the life vests within the aircraft; interrogating, with the handheld RFID inspection device, at least one of the RFID tags associated with the life vests on the airplane and receiving into the handheld RFID inspection device RFID tag information from the interrogated RFID tag; and assigning a status to the life vest associated with the interrogated RFID tag, wherein the status indicates state information about the expected location of the life vest.

In another embodiment, the invention is directed to a method for performing an inspection of life vests on an aircraft comprising storing, in a handheld radio frequency identification (RFID) inspection device, an aircraft profile that includes a unique identifier for a plurality of life vests expected to be on an aircraft, wherein the aircraft profile further includes expected location identification data that defines expected locations of at least some of the life vests within the aircraft; determining inspection device location information, which defines a current location of the inspection device in the aircraft at a point in time during an aircraft inspection; interrogating, with the handheld RFID inspection device, at least one of the RFID tags associated with the life vests on the airplane and receiving into the handheld RFID inspection device RFID tag information from the interrogated RFID tag; using the RFID tag information to look up the location identification data for at least one life vest; comparing the life vest's associated RFID tag expected location identification data against the inspection device location information; and assigning, based on the comparison, a status to a location identification code member of a data set representing expected life vest locations for an aircraft, wherein the status indicates state information about the expected location of the life vest, or state information about the life vest.

In another embodiment, the invention is directed to a method comprising interrogating RFID tags associated with a plurality of life vests on an airplane with a handheld RFID tag inspection device, and receiving into the handheld RFID inspection device at least an identifier from an RFID tag that defines the expected location of a life vest on an aircraft; and associating a status to at least some of the expected locations of the aircraft, wherein the status indicates the state of an expected life vest location.

In another embodiment, the invention is directed to a method comprising interrogating, with a handheld RFID inspection device, at least one RFID tag associated with a life vest on an aircraft; receiving, into the handheld RFID inspection device, RFID tag information from the interrogated RFID tag, wherein the RFID tag information contains life vest expiration data; and, based on the RFID tag data, determining the expiration date of the life vest.

In another embodiment, the invention is directed to a method comprising interrogating, with a handheld RFID inspection device, at least one RFID tag associated with a life vest on an aircraft; receiving, into the handheld RFID inspection device, RFID tag information from the interrogated RFID tag, where the RFID tag information defines the expected location of the associated life vest; determining the location of the RFID tag inspection device, which defines a current location of the inspection device in the aircraft at a point in time during an aircraft inspection; and, based on the expected location of the life vest read from the RFID tag, compared against the location of the RFID tag inspection device, determining if the life vest is not in its expected location.

In another embodiment, the invention is directed to a method comprising interrogating, with a wireless inspection device, a profile storage and retrieval system associated with a vehicle; receiving vehicle profile information from the profile storage and retrieval system, said vehicle profile information defining at least one physical characteristic of the vehicle; inspecting RFID-tagged items on the vehicle using the wireless inspection device, said inspection yielding inspection data; and, analyzing the inspection data in light of the vehicle profile data; and, based on the analysis, providing data to a user indicating at least one expected tagged item was located in its correct placement on the vehicle.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating a high-level view of a user operating a mobile RFID-enabled inspection device to inspect for life vests under aircraft seats.

FIG. 2 is a flowchart showing one example manner in which an airline could receive RFID-tagged life vests and place them on aircraft.

FIG. 3A is a block diagram illustrating a high-level view of an example RFID-enabled life vest inspection system as could be utilized, for example, in inspecting aircraft

FIG. 3B is a block diagram illustrating a high-level view of an example RFID-enabled vehicle inspection system.

FIG. 3C is a block diagram illustrating a high-level view of a less centralized example RFID-enabled life vest inspection system.

FIG. 4 and FIG. 5 are flowcharts showing an example inspection using the RFID-enabled life vest inspection system.

FIG. 6A through 6C are flowcharts showing example techniques in which inspection device location information could be ascertained.

FIG. 7 is a view of an example plane and associated seating configuration.

FIG. 8 through 10 are example screen shots of a user interface.

FIG. 11 and 12 are flowcharts illustrating an example manner in which user interface module might function.

FIG. 13 is a flowchart illustrating an example manner in which a user may generate certain components of an aircraft profile by interacting with user interface module.

FIG. 14 is a drawing of an example life vest with multiple RFID tag location configurations.

FIG. 15 shows example layers of an RFID tag, life vest membrane, and adhesive layer.

FIG. 16 is a modified flowchart showing a life vest being folded and placed into a life vest package.

FIG. 17 is an example view of a life vest package.

FIG. 18A through 18D are diagrams showing repeating RFID tags with alternative tear propagation configurations.

FIG. 19A and 19B are views of an RFID tag affixed in various locations to a life vest package.

FIG. 20A through 20H are graphic illustrations in support of certain testing methodology and results.

FIG. 21 is a diagram illustrating how a user might interrogate a profile interrogation point within an aircraft to receive a vehicle's profile.

FIG. 22 is a flowchart showing a high-level process that may be used to populate on-vehicle storage and retrieval system with a vehicle's profile.

FIG. 23 is a flowchart showing one example manner in which a user may inspect a vehicle where the vehicle's profile has been retrieved from an on-vehicle profile storage and retrieval system.

### DETAILED DESCRIPTION

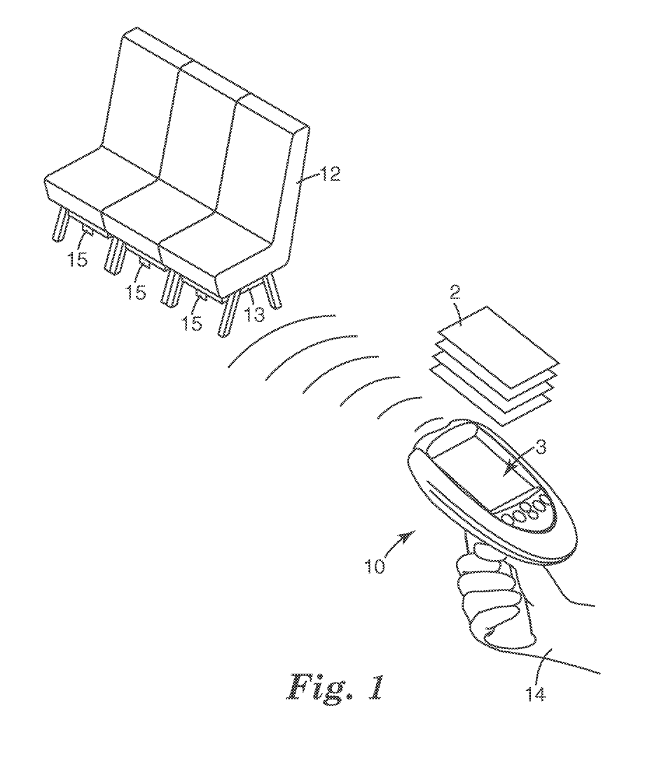

FIG. 1 is a diagram illustrating a high-level view of a user operating a mobile RFID-enabled inspection device to inspect for life vests under aircraft seats. Inspector 14, also referred to as user 14, uses inspection device 10 to interrogate an RFID tag (or label) 15 attached to one or more life vests 13 to determine whether the life vests are properly located under aircraft seats 12 contained within an aircraft. In this example, inspection device 10 includes screen 3, which provides visual feedback and possibly directions to user 14. In one embodiment, and as described in greater detail below, user 14 uses inspection device 10 to inspect the aircraft for present, altered, missing, moved, improper, expired, or soon-to-be expired life vests (or some subset of this list). Though described herein with respect to using RFID technology to inspect for life vests on an aircraft, the same techniques may be used to inspect other vehicle types, such as boats, tankers, trains, automobiles, trucks, busses, emergency vehicles (fire trucks, police cars, ambulances), space crafts, motor bikes, bicycles, or any type of vehicle for items such as life vests, fire extinguishers, smoke or fire detectors, seats, emergency slides, safety equipment, signs and placards, oxygen-generating canisters, oxygen tanks, electronic equipment (e.g. entertainment equipment) or any item being time-sensitive (e.g. having an expiration, maintenance, and/or calibration date), a specific serial number, a specific location or quantity required on a vehicle. A vehicle, as the term is used herein, refers to any apparatus by which someone travels or something is carried or conveyed. Types of vehicles include those mentioned above, but also include aircraft, spaceships, satellites, and submarines.

User 14 may be any authorized personnel charged with inspecting an aircraft for the presence or absence of life vests. The specific role of user 14 usually depends on the type of inspection being conducted. User 14 may go through an authentication process to ensure he or she is authorized to make the inspection, or to at least record which particular user was facilitating the inspection. This could be done by interrogating an RFID tag associated with the user him- or herself, via for example an identification badge. There are generally two types of routine life vest inspections (there may of course be ad hoc inspections to address other needs). The first inspection type is a pre-flight inspection, which is typically made by the flight attendant or gate mechanic. This pre-flight inspection confirms the presence of the life vest under the seat or where otherwise expected. If a life vest is missing, the inspector provides a new life vest or the corresponding seat is not used on the flight. The second type of inspection is a more comprehensive inspection made by mechanics or other personnel as part of routine maintenance. At these inspections the life vests are inspected not only for their presence but also their expiration dates.

Inspection device 10 represents a portable device having an RFID antenna, RFID circuitry for interrogating RFID tags, and an internal processor or other computing device. The RFID device produces electromagnetic fields for interrogating (i.e., communicating with) RFID tags 15 attached to life vests 13. Inspection device 10 includes inspection device screen 3, which may be any type of screen that conveys visual information to a user, but in preferred embodiments is a liquid crystal display, or light emitting diode-based display. Screen 3 provides visual information to user 14. This information may include information about the inspection, such as which life vests 13 have been identified. It may also direct user 14 to inspect a certain row, or re-inspect a row after an exception condition is identified. Screen 3 displays, in part, a graphic user interface to user 14, which facilitates or assists in facilitating inspection of the aircraft. Inspection device 10 may also include a speaker or other audio device capable of signaling and communicating with user 14. The audio device provides useful information to inspector 14 to facilitate inspection of the aircraft.

Inspection device 10 generates exception reports 2. Exception reports may be graphically rendered on screen 3 or printed on paper, or otherwise may be any visual or audio indicia that indicates a possible exception condition (e.g., the absence of one or more life vests 13, or the presence of one or more life vests 13 that are not consistent with aircraft records (for example, where the life vest is expired, moved, or has been tampered with)).

In one embodiment, inspection device 10 provides two general types of reports: real-time and summary. Real-time reports include the feedback presented to user 14 in the course of an inspection. Real-time reports may, for example, show the status of each row/seat for which a life vest has been located, as well as seats for which an exception condition exists warranting manual follow-up by inspector 14, such as a missing or expired life vest. Real-time reports are primarily consumed by inspector 14. Summary reports contain basically the same type of information as real-time reports, but are generated at the conclusion of the inspection. They are generally archived as part of an airplane profile, as will be discussed further, and may be more appropriate for consumption by, for example, regulatory agencies or management.

Ideally each life vest 13 on an aircraft is marked with an RFID tag 15. RFID tags 15 can be selected based on the appropriate frequency. In one embodiment, tag 15 functions at a frequency considered for aerospace applications (e.g., either 13.56 MHz or 915 MHz). However the invention is not limited to these frequencies. The selected frequency may extend or limit the read range of inspection device 10. For example, one embodiment described below involves interrogating life vest containing areas one row at a time. At limited read ranges, it may be necessary to interrogate one seat at a time by aiming inspection device 10 at an individual seat, or at multiple seats as the range allows. A preferred tag for one embodiment might be based on frequencies that give greater read range. Although passive tags are mainly considered with respect to the example description of this invention, an alternative is to use active tag technology, where the RFID tag includes its own power source. If an active tag system were used, the read ranges could be sufficient to make a complete inspection of the total aircraft from one location.

Different methods may be used to store data on RFID tags 15 associated with life vests 13, and the specific data recorded can be tailored to the needs of the airline and life vest manufacturer. In some embodiments, the basic data defined by EPCGlobal™ Class-1 Generation-2 Ultra High Frequency RFID Protocol can be used. This is a protocol for how data is laid out and collected in the RFID tag. Other protocols could also be used. In this example, the data may include a unique identifier, manufacturing information (manufacturer, place of manufacture, time of manufacture, and other related information), and other data that defines and further identifies the life vest (for example, type of vest, or maintenance history of the life vest (such at service dates and repair type, if applicable)).

In some cases, data associated with the life vest is stored on the RFID tag itself, and if the data set is small, a 96 Kbit chip will be sufficiently large to handle most of the data. Alternatively, the data concerning a life vest may be held in a central computer system with unique identifier numbers assigned to the RFID tag 13 on each vest. A subset of this information can be associated with a particular airplane's profile and provided to inspection device 10 before an aircraft is inspected, as will be described further.

In various embodiments, location information of inspection device 10, at the point of inspection, herein referred to as inspection device location information, is useful at the time of interrogation or later in order to identify a negative situation, namely the absence of a life vest 13 in its expected location (expected location being defined as the data set representing the life vests' expected location information). Inspection device location information may be used to determine the expected state for each seat or other discreet area of an aircraft. Expected state information defines, for example, what life vests are expected in the coming set of interrogations. For example, when user 14 interrogates the twentieth row of an aircraft, the inspection device location information could be used to automatically look up the twentieth row in a database. This look up could retrieve information showing that the twentieth row contained two seats, and the two seats have life vests with RFID tags that having unique alphanumeric identifiers of A385 and E583. Further information retrieved could show that A385 has an expected location of seat 20B and an expiration date of Mar. 10, 2015, and E583 which has an expected location of seat 20A and an expiration date of May 15, 2017. In this example, the expected state information for the discreet inspection event comprises: the fact that the row contains two seats, the unique identifiers of the RFID tags on the life vests, the expiration information, and the expected location information associated with each life. If the interrogation, or inspection, of the twentieth row reveals a data set that does not match the expected state information, the entire row may be first marked as suspect. Depending on the specific information that is retrieved during interrogation, however, some of the seats may be deemed to be acceptable, and thus de-marked. This would be the case, for example, when there is row of several, say three, seats and two of the seats match expected state information. Only the third seat would be marked as suspect, which via the user interface displaying repots 2 on screen 3, would alert inspector 14 to follow-up on this seat. In other words, at a high level, determining whether a life vest is absent is a function of comparing the data set of an inspection event (for example, the interrogation of a row) to expected state information for that row. The same is true for inspection events that are seat-by-seat, or possibly aisle by aisle, or plane by plane. If a row has one seat, the expected state condition would be defined as such, and the comparison between what life vests are present and what are expected to be present would only involve one life vest. The particular scope of an inspection event is an implementation-specific detail; differing scopes may have advantages and disadvantages depending on particulars of the application. For example, certain aircraft may be deemed flight-worthy after an inspection that shows an acceptable number of life vests were confirmed, by inspection of their associated RFID tags, to be onboard an aircraft. Or, certain aircraft may be deemed flight-worthy only after an inspection that confirms the proper number of life vests have a seemingly proper distribution throughout the aircraft (they are not all bunched up in a cargo hold in the aircraft's rear, for example). Or, as yet another example, certain aircraft may be deemed flight-worthy only after an inspection that confirms that each life vest of record under each seat is in fact under that seat. These three examples show varying requirements of positional resolution—various techniques or combinations of techniques may be used to achieve each of these positional resolution requirements.

Tests of some aspects of various inspection methods were conducted on a Boeing 737 and 747, a McDonnell-Douglas DC9 and 10, and an Airbus A300. Life vests were installed under seats in five rows of each aircraft. Test results are summarized later in this specification. The testing revealed instances where, for example, the first seat in the row being interrogated was not immediately detected, but seats from adjacent rows (or even further away) were detected. These phenomena may be the result of metal components in seats, or metal components used in the aircraft, which cause multiple signal paths between the inspection device and the RFID tags. Further, metal structure within and beneath the seats could depolarize radio frequency signals. These phenomena are generally termed “multi-path,” and certain techniques described herein take advantage of them. The term multi-path refers to any interrogation of an RFID device wherein the radio frequency traversal path is not direct, and is instead reflected or deflected off another surface, or whereby another material transmits the radio frequency.

Aircraft seats on some aircraft include a metal pan, which may operate as an insulating shield. One approach to successful interrogation of an RFID tag located under an aircraft seat that contains a metal pan is to reflect the radio frequency signal off a conductive surface such as the floor of an aircraft, thereby taking advantage of multi-path RFID interrogation. The path the radio signals must travel when reflected off another surface such as the floor are generally longer than interrogation of the RFID tag directly, so an increase in the radio signal power of the interrogation device is sometimes helpful, though not always necessary. Of course, the increased power may cause other RFID tags under other aircraft seats to be successfully interrogated.

Expected state information may exist or be derived at several levels, and each has advantages or disadvantages. Ideally, expected state information is defined for each model interrogation set by inspection device 10. A model interrogation set is defined by the scope of an inspection event. For example, if inspection device 10 is inspecting the aircraft by row (a model interrogation set), expected state information would ideally be available by row. An inspection event would be, in this example, when the inspector aims inspection device at the row, pulls the trigger of inspection device 10, and receives feedback that information concerning the row has been received by inspection device 10. Such feedback might be, for example, an auditory beep, or an update of visual indicia on screen 3. Alternatively, no feedback is needed to define the end of an inspection event. The end of an inspection event could be defined by protocol if, for example, user 14 merely made sure an inspection event was at least a minimum period of time, say two seconds.

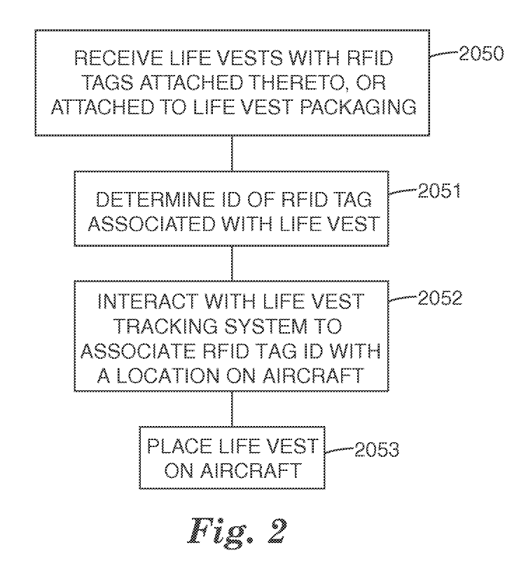

The life vests 13, with attached RFID tags 15, are delivered to either the airline, to be installed on the seats by airline mechanics, or alternatively, to the seat manufacturer who will pre-install life vests 13 on the seats 12 before they are delivered to the airline. FIG. 2 is a flowchart showing one example manner in which an airline could receive RFID-tagged life vests and place them on aircraft.

First, life vests are received by the airline, which have already been affixed with RFID tags (2050). As mentioned earlier, the airline may receive these life vests already attached to seats, from the seat manufacturer. Alternatively, the airline may receive the RFID tags and attach them to life vests it already has, or hire contractors to do it. This is called retrofitting RFID tags to life vests. Finally, it will be appreciated that it is not necessary to affix an RFID tag to a life vest itself. Rather, the RFID tag might be affixed to the packaging into which the life vest is placed. This technique is described further else ware in this specification.

Next, the airline may inventory the RFID tag associated with each life vest (2051) and receive back from the RFID tag at least a unique identifier. With this unique identifier, the airline may then update the RFID-enabled life vest tracking system to associate the unique identifier with a location on the aircraft where the attached life vest will be stored (2052). This location may be, for example, a seat number, which may indicate a life vest is associated with the underside of the seat (a location where life vests are typically stored on aircraft). Information identifying where a life vest is expected to be located is termed a life vest's expected location information. The life vest's expected location information may either be stored on the RFID tag itself, or it may be stored in a database elsewhere, or both. Those skilled in the art will appreciate that this is an example only, and that a fully unique identifier may not be necessary, especially if a unique identifier may be derived from the eventual loading of expected location information onto the life vest. In other words, the expected location information may form the basis of a unique identifier, either alone or hashed with some other identifier, such as a number or key that identifies the particular aircraft.

Finally, after the unique identifiers associated with each life vest have been associated with expected location information, the life vests are placed on the aircraft (2053). In a different embodiment, the unique identifiers associated with each life vest may be associated with expected location information after the life vests have been placed on the aircraft by, for example, putting the inspection device into a learn mode then stepping through the basic steps of an inspection. Regardless of point in which life vests are associated with expected location information, once the association is completed, life vests may be inventoried using some embodiments of methods, techniques, and devices discussed further in this specification.

As mentioned, when life vest 13 containing RFID tag 15 is finally installed on an aircraft, the RFID tag 15 and thus life vest 13 may be associated with a location on the aircraft (the life vest's expected location information). The expected location information is usually data defining a given seat in the aircraft under which life vest 13 containing RFID tag 15 is located, but it could be any information that defines a location on the aircraft, such as a seat number or locker location. Life vest 13's expected location information can either be stored on life vest 13's RFID tag 15, or it can be stored in a separate database. For example, the information could be stored in a database maintained by the airline, then accessed before or after an inspection by user 14. Unless otherwise stated, assume for the purposes of example in this specification that the RFID tags on life vests contain expected location information in the form of seat numbers, and that this information is also, or alternatively, contained within a central database of the life vest tracking system.

In some embodiments, it may not be necessary to associate life vest RFID tags with expected location information. Inspector 14 may inspect the aircraft without life vest expected location information ever having been associated with a life vest. This would be the case, for example, if a user supplied the expected location information at the time of life vest RFID tag inspection. For example, if user 14 aimed inspection device 10 at a row of three seats, user 14 would expect three unique RFID tags to respond to the interrogation. If three RFID tags where not successfully interrogated, user 14 would know there was an issue that required further manual inquiry.

This approach may be expedient, but may also require ensuring the signals being received by inspection device 10 originate from the RFID tags associated with the seat or set of seats user 14 is inspecting. For example, a problem may arise if device 10 erroneously receives signals from life vest tags under seats in front of or behind the groups of seats user 14 believes he or she is interrogating. This issue may be addressed, however, by adjusting the signal strength emanating from the RFID reader and estimating the distance between the inspection device and the RFID tag based on the signal strength at which an RFID tag responds to a signal or ceases to respond to a signal, measuring the signal strength emanating from the interrogated RFID tag, focusing the aim of radio signals emanating from inspection device 10, not double-counting RFID tags already read, shielding, or other approaches for eliminating or ignoring extraneous signals.

This technique is just one example of how RFID tags attached to life vests could be inspected without associating each RFID tag with expected location information. Another way would be to perform seat-by-seat inspections in which user 14 places inspection device 10 proximate (e.g., immediately above) each seat such that only an RFID tag under the seat being interrogated would be energized and respond to the interrogation. In this way, no proximity information need be associated with the life vest RFID tag itself in order to confirm the presence of life vests on an aircraft. However, there may be benefits in associating expected location information with each life vest. In particular, such information may be useful as an aid to determining whether a life vest has been moved, which may be indicative of tampering and require subsequent follow-up by user 14.

User 14's flow through the aircraft may be self-directed or may be directed at least in part by inspection device 10. If the inspection of an aircraft is directed by inspection device 10, or must be done in an order pre-specified, this is referred to herein as a defined protocol inspection. A defined protocol inspection might be, for example, where inspector 14 is required to first inspect the first row, then the second row, and so forth. Use of a defined protocol inspection may aid determining the location of inspection device 10 at any point during the inspection. This and other techniques for determining where an inspection device is at the point of inspection, will be discussed further else ware in this specification. However, in certain embodiments of the invention, user 14's flow through the airplane is self-directed for at least the pre-flight type inspection, and does not require a defined inspection protocol. In other words, in these embodiments, inspector 14 may start inspecting aircraft at whatever position he or she likes, may skip over seats or sections and come back to rows, and so forth, and the inspection is not compromised.

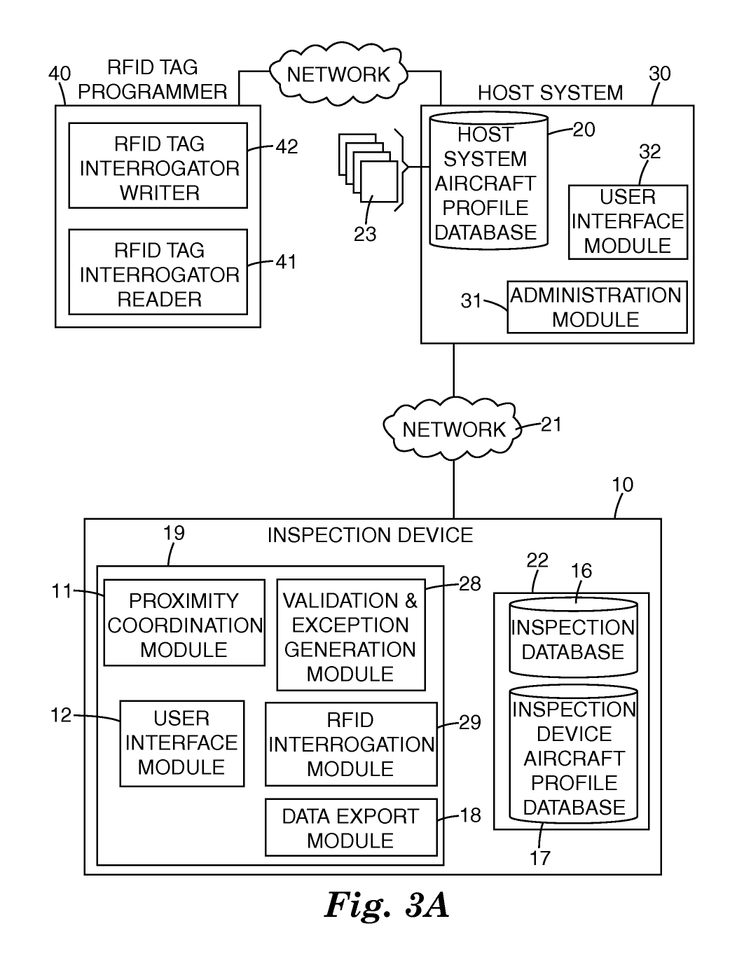

FIG. 3A is a functional diagram showing an example embodiment of a vehicle inspection system, particularly an aircraft life vest inspection system, including inspection device 10, host system 30 and RFID tag programmer 40, which collectively support aircraft inspections for life vests 13 containing RFID tags 15. Though described herein with respect to an aircraft, the same concepts described herein could be applied to inspecting items, other than life vests (such as mechanical parts, engine parts, electrical parts, smoke detectors, and so forth), on any type of vehicle (boats, cars, busses, trains, space ships, satellites, submarines, etc.), as one skilled in the art will readily appreciate. FIG. 3B demonstrates one example manner in which the inspection system in FIG. 3A could be abstracted to apply to inspecting any type of vehicle for any type of item or condition on or associated with that vehicle. Host system 30 may be a centralized computer system that houses a host aircraft profile database 20. Host system 30 also includes user interface module 32, and administration module 31, which represent software modules executed by one or more processors and stored within a computer-readable storage medium. Both of these software modules may be run on a separate system or over the Internet on web browsers for example.

All databases described herein may be implemented in many ways, as will be evident by one skilled in the art. The databases may take a variety of forms including data storage files, or one or more database management systems (DBMS) executing on one or more database servers (which may be running on the handheld, or may be connected to the handheld via a wireless link (802.11x, for example)). The database management systems may be a relational (RDBMS), hierarchical (HDBMS), multidimensional (MDBMS), object oriented (ODBMS or OODBMS) or object relational (ORDBMS) database management system. Databases could, for example, take the form of a single relational database such as SQL Server from Microsoft Corporation.

Host system aircraft profile database 20 contains aircraft profiles 23. Aircraft profiles 23 may include, for example, information about particular aircraft. This information may include the type of aircraft, a layout of the aircraft, a graphical representation of the aircraft including, but not limited to, row, aisle and seat arrangements, storage area arrangements, and information defining the expected location of each life vest 13 on the aircraft, and possibly the life vest inspection history of the aircraft. The aircraft profiles 23 also may include unique identifiers for each life vest 13, and these unique identifiers may be associated with a location code (such as a seat number) that defines the location within the aircraft where a particular life vest 13 should be found if it has not been moved. The aircraft profiles 23 may include notes or procedures useful to inspector 14 at a time of inspection. Aircraft profile may include code, or scripts, that executes on inspection device 10 and alters default behavior (for example, the script may say that for a given class of plane, a particular life vest not being found is not an exception condition). Aircraft profiles 23 may be located in locations other than a host profile database 20. For example, profiles could exist, pre-loaded or otherwise loaded, onto an inspection device, without the use of a central computer. This could be of benefit to operations that have a limited number of aircraft, or are otherwise uninterested in maintaining a centralized host system 30 The aircraft profile could also exist within, and be retrieved from, an RFID tag on, within, or in proximity to the aircraft itself. For example, an inspector could scan a profile-containing RFID tag, or cluster of RFID tags, which contain the aircraft's profile at a particular location in the aircraft, as further described herein with respect to aircraft inspection system illustrated in FIG. 3C.

Host system 30 also includes user interface module 32 and administration module 31. Administration module 31 allows the importation, updating, reviewing, and reporting of information contained within aircraft profiles 23. Administration module 31 also facilitates the creation of new aircraft profiles, or the elimination and/or archiving of old aircraft profiles. Administration module 31 interacts with a user via user interface module 32. User interface module 32 may be enabled via a web browser, it may be a standalone program running on the same host system as host aircraft profile database 20, or it may be hosted on a separate system, in a client-server configuration.

Connected to host system 30 is RFID tag programmer 40. RFID tag programmer 40 facilitates the inspection and/or programming of RFID tags without the use of inspection device 10. In this example, RFID tag programmer 40 contains two software modules, one for reading the contents of an RFID tag (RFID tag interrogator reader 41) and one for writing content to an RFID tag (RFID tag interrogator writer 42). RFID tag programmer 40 contains supporting hardware for these software modules (not shown). RFID tag programmer 40 is used to inspect RFID tags associated with life vests and to reprogram life vest RFID tags. The same activity may be done in the field, in the course of an inspection, with inspection device 10. However, in some embodiments, it is advantageous to centrally manage the distribution of life vests, and centrally maintain information about life vest dissemination. RFID tag programmer 40 would be used, for example, if an airline issued life vests from a central location, at the request of an inspector or automatically via an inspection device, wherein the request included an RFID tag be generated for a particular location on an aircraft, and this expected location information be coded into the RFID tag and also put into the aircraft profile 23. A user would use administration module 31, through user interface module 32, to program a newly issued RFID tag associated with a life vest, and update aircraft profile 23. The life vest would then be issued and placed in its proper location by airline personnel.

In this example, inspection device 10 is composed of software modules 19 and one or more local databases 22 (e.g., inspection database 16 and inspection device aircraft profile database 17), which may be organized in a form suitable for storing and retrieving data within a portable device. Software modules 19 interact with databases 22 to determine expected location information for life vests, expected state information for an inspection event, inspection location information of the inspection device 10 at point of an inspection event, and ultimately whether a life vest is present, in its proper location, and whether it is expired. Other information or attributes could be checked against databases 22. In other embodiments, some or all of this information is determined remotely by host system 30 based on data retrieved from tags 15 via inspection device 10. Proximity coordination module 11 determines the location of the inspection device at the point of an inspection in one of several ways, as described herein, or it may be deactivated for certain types of inspections.

User interface module 12 facilitates visual interactions with user 14 via screen 3. Particularly, user interface module 12 draws user interface screens that facilitate user 14's inspection of an aircraft for the presence or absence of life vests. The specific user interfaces produced by user interface module 12 are described later in this specification.

RFID interrogation module 29 interrogates RFID tags and receives information back from the interrogated tag. RFID interrogation module 29 may also utilize a controlled strength of interrogation signal, as well as in some embodiments sensed strength of the return signal from the tag, to aid in the determination of the actual locations of RFID tags and their associated life vests. Information concerning the interrogation generated by RFID interrogation module 29 is placed into inspection database 16, where it may be analyzed by validation and exception generation module 28.

Inspection device aircraft profile database 17 contains one or more of profiles 23, or subset of a profile 23, as primarily stored within host system aircraft profile database 20, and subsequently downloaded onto inspection device 10 in anticipation of an inspection of life vests on an aircraft. The profile 23 may be accessed by inspection device 10 via network 21. Network 21 could be the Internet, or it could be an internal, private network. It could be a traditional wired network, or it could be wireless. Inspection device 10 uses network 21 to retrieve an aircraft profile 23 from host system aircraft profile database 20. As mentioned, profile 23 of an aircraft including location information of the life vests is preferably done before an inspection of an aircraft, but in one embodiment the data validation and comparison is completed after the raw data has been gathered via an inspection. In such a scenario, inspection of an aircraft is completed, and then the inspection data is later analyzed in light of aircraft profile 23, and an exception report generated. This functionality may be useful, for example, where host system 30 was inaccessible at the time an inspection was initiated. In another embodiment, the profiles are stored in the inspection device itself, and no host system is necessary.

Data export module 18 facilitates the exportation of data from inspection device 10. Such data could include an updated profile, such as would be generated if a life vest were reconfigured during the course of an inspection (for example, the expected location information of a life vest were re-set). Data export module 18 also facilitates the exportation of reports that summarize inspections, and raw data from an inspection for analysis.

Validation and exception generation module 28 contains logic that assesses inputs generated from other modules, in combination with information from the inspection device aircraft profile database 17, and determines when life vests are misplaced, expired, or otherwise need follow-up. Validation and exception generation module 28 sends this information concerning the status of the inspection to inspection device aircraft profile database 17, then requests user interface module 12 to update its user interface using the new inspection device aircraft profile database 17 information. More specifically, validation and exception generation module 28 determines or receives inspection device location for an inspection event (if this information is received, it is received from proximity coordinate module 11; if this information is the result of a defined protocol inspection, the inspection device location information at the point of an inspection event is determined internally to the module). Inspection device location information is used to look up in inspection device aircraft profile database 17 what information is available concerning expected state of an inspection event. The expected state information for an inspection event is compared to actual inspection data as placed into inspection database 16 by RFID interrogation module 29. From this comparison, the inspection device aircraft profile database 17 is updated with information that contains the status of life vests; particularly those that have been located, those that may have been moved, and those that are expired (the latter two categories are marked internally for further follow-up). After each inspection event, validation and exception generation module 28 requests user interface module 12 to update itself with the information newly updated into inspection device aircraft profile database 17 concerning the inspection.

FIG. 3B is a functional diagram showing an example embodiment of a vehicle inspection system. Most components are similar to those described with respect to FIG. 3A. However, the system in FIG. 3B regards a more general vehicle inspection system, whereby any RFID-tagged item can be inspected. For example, host system vehicle profile database 51 contains vehicle profiles 50. Vehicle profiles 50 may include information about a particular vehicle. This information may include the type of vehicle, a layout of the vehicle, a graphical representation of the vehicle including row, aisle and seat arrangements (if relevant to the inspection of that vehicle), storage area arrangements, and information defining the expected location of particular RFID-tagged items on that vehicle, as well as, in some embodiments, the inspection history of the vehicle. The vehicle profiles 50 also may include unique identifiers for items, which may be associated with location codes that define the location within or upon the vehicle where a particular item should be found. Vehicle profiles 50 may include notes or procedures useful to an inspector at the time of, or before or after, an inspection. Such procedures may be part of an inspection protocol, including directions indicating where a vehicle inspection should start or end. Vehicle profile 50 may include code, or scripts, that executes on inspection device 10 and alters default behavior (for example, the script may say that for a given class of vehicle, a particular item not being found is not an exception condition). Vehicle profiles 50 may be located in, and retrieved from, locations other than a host system profile database 51. For example, and not illustrated in FIG. 3B, the vehicle profile 50s could exist, pre-loaded or otherwise loaded, onto an inspection device, without the use of a central computer. This de-centralized architecture could be attractive to operations having a limited number of vehicles to inspect, or not wanting to incur costs associated with a centralized host system. Other components described with respect to a life vest inspection of an aircraft may operate similarly with respect to inspecting other types of vehicles for RFID-tagged components or parts, as will be appreciated by one skilled in the art.

Whereas FIG. 3A and FIG. 3B are directed toward a system wherein inspection device 10 is at times communicatively connected (via network 21) with a centralized host system, FIG. 3C is directed toward another example system which in some embodiments may be more autonomous or less centralized. FIG. 3C is a block diagram showing functional modules of an inspection device. As compared with the system illustrated in FIG. 3A and 3B, the inspection device 10 in FIG. 3C includes within it certain functionality for managing and administering aircraft profiles 23 that was previously available in host system 30. Particularly, inspection device 10 in FIG. 3C includes administration module 33. It does not necessarily provide the same functionality described with respect to administration module 31 in FIG. 3A and FIG. 3B. Depending on implementation, administration module 33 includes functionality associated with creating, updating, and editing vehicle profiles.

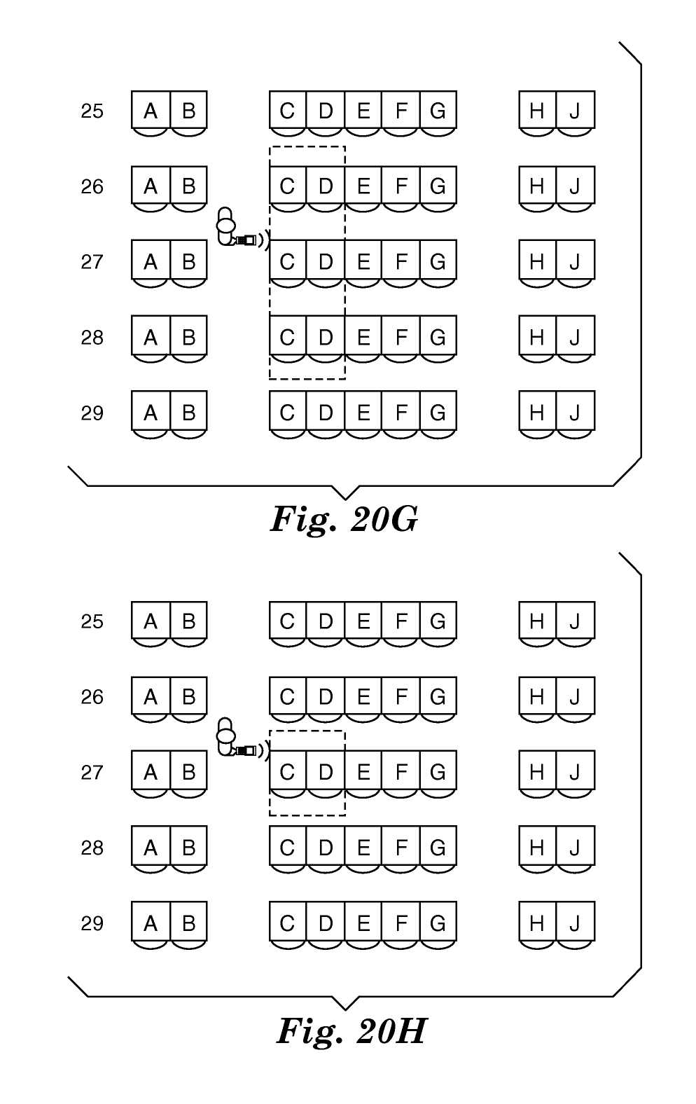

A system similar to that depicted in FIG. 3C may be suited for environments where infrastructure requirements of a centralized host system are not practical or undesirable, for example. Further, due in part to the fact that most or all necessary software components are housed within inspection device 10, deployment may be simplified. Also, inspection devices may not need be stored within or associated with a particular vehicle, aircraft, or so forth. Rather, any of a plurality of inspection devices could be used to inspect any of a plurality of aircraft for any of a plurality of things or conditions of interest on a particular vehicle. The same inspection device 10 could one moment be used to inspect a bus, and the next be used to inspect an aircraft. It will be appreciated that the same techniques described with respect to an aircraft in FIG. 3C apply to other types of vehicles. For example, one skilled in the art will recognize that a common vehicle inspection profile definition standard could be deployed such that any inspection device 10 supporting a particular profile definition standard could be used to receive a vehicle profile, and then use it for inspection of the vehicle. Similarly, standardized, possibly industry-sanctioned or adopted inspection protocols may be programmatically implemented within inspection devices. Then, upon interrogation, inspection device 10 may receive information from a vehicle profile-containing RFID chip indicating that the profile being transmitted is, say, for a school bus versus an aircraft. The appropriate “school bus inspection protocol” may already exist within inspection device 10. Alternatively, inspection protocols themselves may be contained within the vehicle profile. An inspection protocol defines at least some particulars about how an inspection takes place, and examples of inspection protocols are discussed further below.

Where vehicle profile information is received from on-board means, such as an RFID tag located somewhere in or on the aircraft and containing the aircraft's profile, inspections generally start with the interrogation of the profile-containing RFID tag. FIG. 21 shows a cut-away of aircraft wall 35 where user 14 is interrogating profile interrogation point 34 with inspection device 10. FIG. 21 shows an interrogation point on a wall of an aircraft, but this interrogation point could just as well be at a plurality of locations within the aircraft. For example, one interrogation point might exist for different sections of a vehicle (main deck, upper deck, etc.), or there may even be an interrogation point on each row that returns row profile information with every interrogation of a row. After successful interrogation, a vehicle profile is returned to the inspection device, and inspection of the vehicle may commence. Profile interrogation point 34 may in one embodiment be one or more RFID tags. For the purposes of description and not limitation, many of the examples contained herein assume that, when the profile is retrieved from an on-vehicle device, the profile comes from an RFID tag located within the vehicle. However, one skilled in the art will appreciate that the profile-containing RFID tag is just one possible means of holding and providing a vehicle profile. Rather than an RFID tag, the profile interrogation point 34 could instead merely signal an area where inspection device 10 has a strong communication signal with a transponder connected to an on-board memory device (a hard drive, flash RAM, etc.). The profile could then be wirelessly communicated to inspection device 10. In other embodiments, there may be no profile interrogation point 34 per se, and instead a wireless access point to a network (provided within a suitably equipped aircraft or vehicle), which receives the signal from inspection device 10, possibly authenticates the signal via one or more security protocols, then responds with the vehicle profile. Such a wireless access point type setup may be increasingly supported as more vehicles and aircraft include, for example, support for wireless networks.

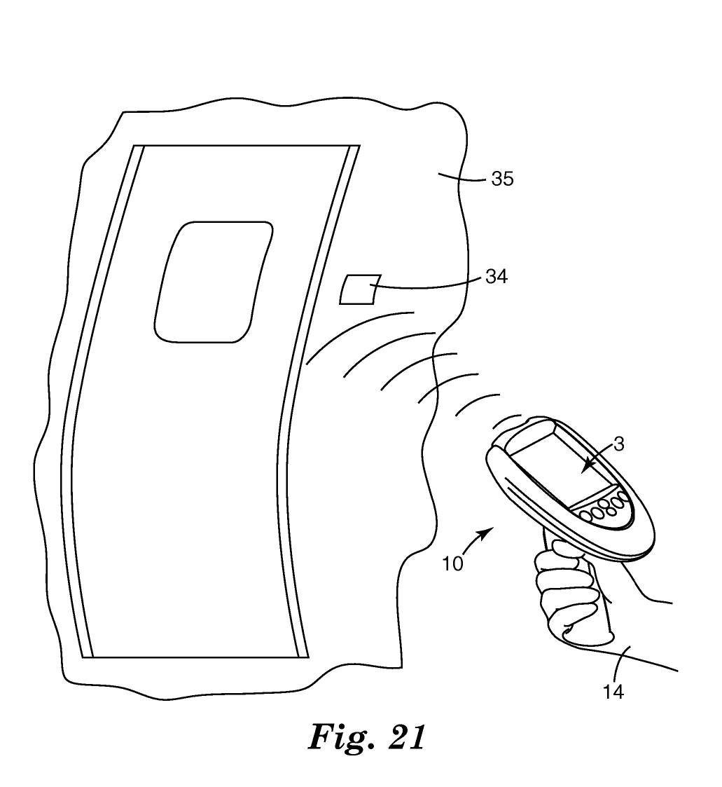

FIG. 22 is flowchart showing the high-level process that may be used to populate an on-vehicle storage and retrieval system with a vehicle's profile. First, a profile storage and retrieval system is installed on or in the vehicle (22A). The profile storage and retrieval system could be as simple as bar codes or other optically-scanned areas that contain information about the vehicle which is used for that vehicle's inspection (e.g. the vehicle profile). The profile storage and retrieval system could also be an RFID tag, or a cluster of two or more RFID tags, that, when interrogated, provide the vehicle profile. Possible RFID tags that could be used as the storage and retrieval system for a vehicle profile include passive or active, with or without an on-board power source. RFID tags can range in storage capacity from less than 1024 bytes to more than 64,000 bytes. Depending on the size of the vehicle profile, several RFID chips may be clustered in one area, each providing a portion of the vehicle profile when interrogated by inspection device, which is then assembled by the inspection device to form the whole vehicle profile. As mentioned above, the profile storage and retrieval system could be an on-board computing system, in wireless communication with inspection device 10. The profile storage and retrieval system could also comprise a computer, possibly a modified personal computer, which emulates an RFID tag. The profile storage and retrieval system, though described herein as in wireless communication with inspection device 10, need not, in all implementations, be wireless. For example, the profile storage and retrieval system could interface with inspection device 10 via a universal serial bus (USB) connection, possibly to a passive or active memory device. Among other things, the use of a USB connection may allow for much higher memory storage capacity. Similarly, other memory storage devices, such as memory cards, could be used. Even further, the profile storage and retrieval system could comprise one or more RFID tags of different frequency to those used on items, such as life vests, within or onboard a vehicle. For example, the profile-containing RFID tag might be a high frequency tag, whereas the RFID tags used to track items might be an ultra-high frequency tag. Once the vehicle profile storage and retrieval system is installed, the vehicle may be configured with RFID-tagged parts (22B). In the case of an aircraft where life vests are to be inspected, this step may include actually placing the RFID-tagged life vests on the aircraft. Particular configurations will vary by application, but this step concludes with RFID tags being situated in the vehicle such that they can be interrogated. The vehicle profile is then constructed (22C). This may be done by an application within the inspection device, in one embodiment, or may be constructed in some other computing environment, then transferred and/or uploaded by some other device. The specifics of where and how the vehicle profile is constructed are an implementation-specific detail. Some implementations may have a particular profile that has relevance to a number of vehicles, and the profile may change only rarely. In such an implementation, the profile storage and retrieval system could be pre-loaded with an appropriate profile. If the vehicle's profile changes more frequently (for example, seating is often moved, and the RFID-items to be inspected are associated with seating), or is more customized (as opposed to more general), inspection device 10 may include software that facilitates changing the vehicle profile (such as administration module 33). In such a case, a generic vehicle profile template may exist initially either on inspection device 10 or in the profile storage and retrieval system, which may then be updated by inspection device 10. The template may include a data structure relevant to a type of vehicle, for example. Finally, the vehicle profile is uploaded to the profile storage and retrieval system (22D). The particular mechanism used to upload the profile is dependant on the technology employed to provide the profile storage and retrieval system. For example, if the profile storage and retrieval system is an RFID tag or cluster of RFID tags, the RFID tag may simply be re-written. Alternatively, if the profile storage and retrieval system is a computer system wirelessly connected to inspection device, a security protocol may be invoked before the actual transmission of the vehicle profile. The security protocol may optionally involve an authentication step.

The manner in which the vehicle profile is uploaded and stored within the profile storage and retrieval system is yet another implementation-specific detail. Certain implementations may implement standard encryption/authentication algorithms to authenticate either the inspection device 10 (if the inspection device is uploading the vehicle profile), or the vehicle profile storage and retrieval system. In one embodiment, where the profile storage and retrieval system comprises one, or a cluster of two or more, ultra high frequency RFID tags, each tag is initialized with a unique identifier, which facilitates distinguishing one tag from another, as well as interrogating a cluster of RFID tags, and then assembling their data. If the RFID tag is destined to be part of a cluster of RFID tags, the unique identifier may adhere to a schema whereby the identification number itself indicates whether the RFID tag is part of a cluster, which cluster it is a part of, and how many tags comprise that cluster. This schema may be represented as follows:
<cluster identification #><RFID tag # within cluster><total # RFID tags in cluster>

Data written to the RFID tag may be write-locked, which prevents certain tampering efforts by requiring the transmission of a password before the writing to the RFID tag. Password-supported RFID tags are available in the marketplace by several vendors. Depending on the sensitivity or criticality of the data being stored on the RFID tag, the data comprising the vehicle profile may be encrypted using known symmetric or asymmetric methods. Also, the data may be converted and stored in a binary format, which may not be as readily comprehendible as more traditional text-storage formats.

Data on the tag itself may be formatted in any manner that can be read by software running on inspection device 10. An extensible markup language format could easily be adapted to describe relevant particulars about the vehicle being inspected. One exemplary format schema, in this case adapted for use inspecting aircraft, is as follows:

Each physical RFID tag that is part of the profile storage and retrieval system includes a header containing the following information:

1) Data map version number. This number indicates which formatting version is used for storing the vehicle profile data on the RFID tag.
2) Full write indicator bit. Inspection of this bit indicates whether the RFID tag was written successfully. Among the first steps in a write operation is to set this bit to false. Then, writing of the RFID tag commences. A final step is to set this bit to true.

Subsequent reads of the RFID tag confirm the bit is set to true. If it is not set to true, this may be indicative of a data integrity issue.

The RFID tag additionally includes a header section containing information about the aircraft profile. It may include, for example, the following information:

1) Aircraft registration number. Unique number for the aircraft (e.g. N123456).
2) User ID. Identifier of the person who wrote the configuration to the config tag.
3) Location. Name entered by user to define the location where the configuration was written
4) Datestamp. Indicates when the aircraft profile was written to the tag (e.g. Dec. 22, 2006 13:23).
5) Config tag full write indicator. This operates in concept similar to the full write indicator bit, but pertains to the entire cluster instead of an individual RFID tag.
   The remaining memory for the RFID tag may contain the following information, optionally spread across multiple RFID tags as a cluster:
1) Seat map name. User defined unique name (e.g. A330-300 v2 333)
2) Seat map update date/time. When the profile was last modified and saved on the inspection device.
3) Active. Boolean defines if this is the active seat map if there are multiple seat maps for a given aircraft registration number.
4) Main Deck information. Information defining layout information regarding aircraft's main deck.
   a. Number of aisles
   b. Max number of seats per row
   c. Total number of seats
   d. Total number of storage locations
   e. Inspection start row
   f. Aisle 1 position
   g. Aisle 2 position (omit if not needed)
5) Upper Deck information. Information defining layout information regarding aircraft's upper deck, if one exists.
   a. Number of aisles (if 0, then rest of upper deck info is omitted)
   b. Max number of seats per row.
   c. Total number of seats
   d. Total number of storage locations
   e. Inspection start row
   f. Aisle 1 position
   g. Aisle 2 position (if not needed)
6) Seat Pattern information. This section helps conserve config tag memory requirements by listing each pattern only once.
   a. Number of seat patterns-Main Deck. A seat pattern is a sequence of codes that defines the seat letters in a row (e.g. ABC˜DEF to indicate seats A, B, C, an aisle, and then seats D, E, F)
   b. For each main deck pattern:
      1. Pattern ID.
      2. Pattern. E.g. A-C˜D—G˜H-K.
   c. Number of seat patterns-Upper Deck. (Omit if none)
   d. For each upper deck pattern
      1. Pattern ID.
      2. Pattern. E.g. ABC˜DEF
7) Seat Row information. Specific information about each seat row segment. Describes similar row sequences of seats as segments.
   a. Number of seat segments. A segment is a section of seats with the same seat pattern.
   b. For each seat segment:
      1. Deck Flag. 0 for main deck. 1 for upper deck.
      2. Pattern ID. (references one of the above patterns)
      3. From Row #. First row with this seat pattern.
      4. To Row #. Last row with this seat pattern.
      5. Grid Row #. Used by internal algorithm.
8) Storage information. Defines storage areas on the aircraft.
   a. Quantity of storage locations.
   b. For each storage location:
      1. Storage Name. Defined by user. E.g. Overhead Row 4
      2. Storage Number. Used by internal algorithm.
      3. Grid Row #. Used by internal algorithm.
      4. Grid Column #. Used by internal algorithm.
      5. Deck Flag. 0 for main deck. 1 for upper deck.
      6. For each item expected in the storage location
         i. Item Code. These are defined by the 3M system, and may include for example: Adult Life Vest, Infant Life Vest, and Crew Life Vest. This list may be expanded in the future to include other items such as first aid kit, blankets, etc.
         ii. Item Quantity. The quantity of this item expected in the storage location.

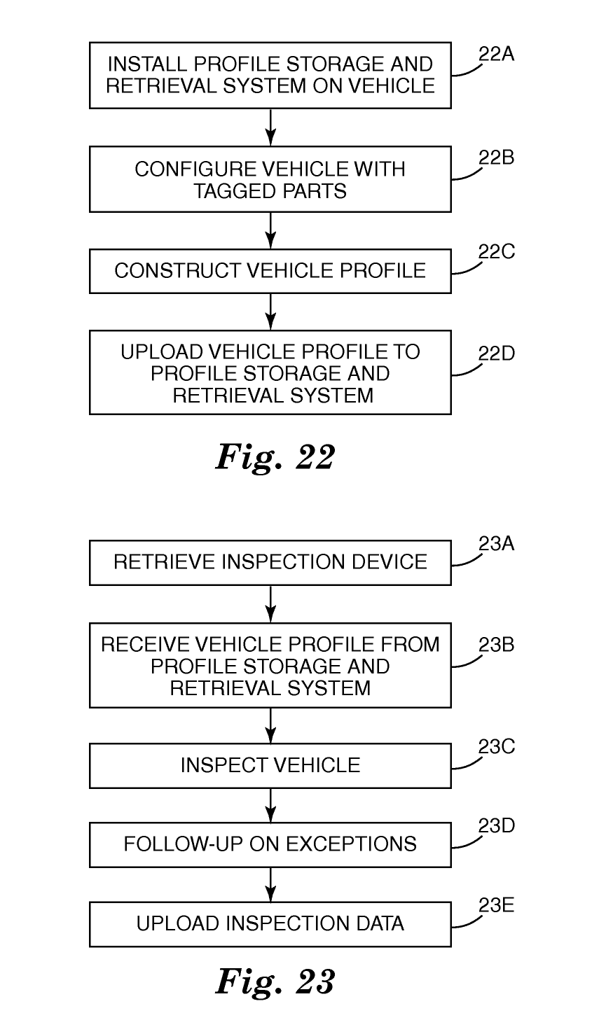

FIG. 23 is a flowchart showing one example manner in which a user such as inspector 14 may inspect a vehicle such as an aircraft, where the vehicle profile (in this case the aircraft profile) is available within an on-vehicle profile storage and retrieval system. First, inspector 14 retrieves inspection device 10 (23A). Inspection device 10 may be located in an area in proximity to the vehicle to be inspected, such as at a gate an airport, or at a maintenance facility. Inspection device 10, in one embodiment, need not be located on the aircraft. Next, the vehicle profile is retrieved from the on-vehicle profile storage and retrieval system (23B). As mentioned above, the process by which the vehicle profile is retrieved is dependant on how the vehicle profile is stored (RFID versus computer system or otherwise). In the case where the profile storage and retrieval system is an RFID chip, the profile interrogation point would be an RFID tag, and the inspector would interrogate the proper area (possibly marked as such), and receive the vehicle profile. Next, inspector 14 commences inspection of the vehicle (23C). The vehicle profile may be loaded and interpreted to provide instructions regarding the inspection (an inspection protocol). Alternatively, inspector 14 may have been trained to execute a proper inspection protocol, so no instructions need be provided on the inspection device. When the inspection is complete, inspector 14 may follow-up on exceptions discovered as part of the inspection (23D). This follow-up may include, as the case may be, remedial activities, such as replacing life vests found missing, or otherwise noting exception conditions for later reporting. In some implementations, once one or more inspections is complete, inspection data may optionally be uploaded from the inspection device to another computer system for archival, analysis, report generation, or other purposes (23E). For example, if the inspection routine being used in FIG. 23 were being used to inspect an aircraft for life vests, the entity responsible for maintaining the aircraft may want reports indicating which aircraft were inspected and what the inspections showed. Inspection device 10, in some embodiments, includes the ability to store data resulting from an inspection of a vehicle. Depending on the storage capacity of inspection device 10, resultant data sets from many inspection events could be stored for later off-load.

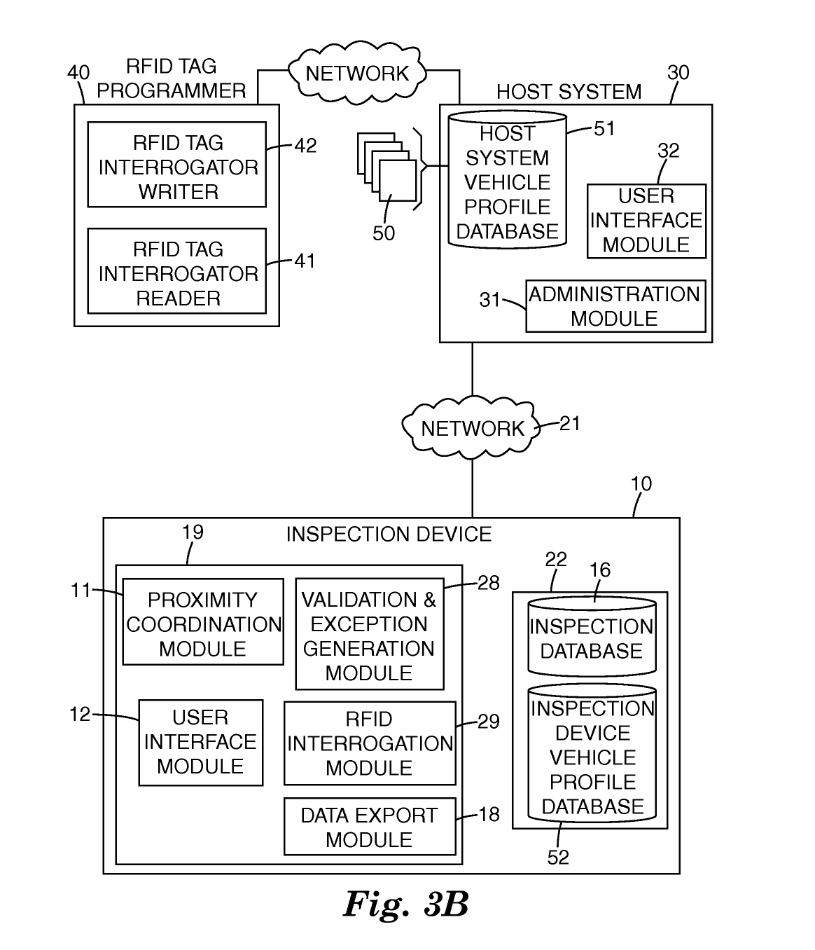

FIG. 4 is a flowchart illustrating one example process in which inspector 14 may use inspection device 10 to inspect for life vests 13 using RFID tags 15. In this particular example, inspection device location information is not used. In other words, analysis of whether a life vest is present or absent turns entirely on the presence of the RFID tag associated with a life vest, and there is no assessment of whether the life vest's expected location information is accurate. With respect to the system software diagram of inspection device 10 as represented in FIG. 3A or FIG. 3B, proximity coordination module 11 would not be necessary for the type of inspection illustrated in FIG. 4 and may be deactivated. This inspection method could be coupled with a defined inspection protocol, say seat-by-seat in ascending order, to produce a very high degree of certainty that a life vest is present or absent from beneath a given seat.

The inspection starts with the retrieval of an aircraft profile (401). The aircraft profile may be retrieved from host system aircraft profile database 20, or may come from an interrogation of an aircraft profile-containing RFID tag located on, or in proximity to, the aircraft. The profile may only be a subset of the entire profile—for example it may only define the seating configuration of the aircraft, contain a graphic rendering of the aircraft (or contain enough information such that a graphic rendering could be done by user interface module 12), and include expected location information for each life vest with an associated RFID tag on the aircraft (if such expected location information is not already present on the RFID tag itself). Receiving a profile at the start of an inspection may not be necessary, and the system, in one embodiment, accommodates the possibility that a profile simply isn't available. There are several ways to proceed with an inspection in the absence of an aircraft profile. For example, if expected information location for a life vest is already on the RFID tag, the profile is not critical. Alternatively, expected state information is supplied by inspector 14 (when inspecting a row of three seats, three life vest “pings” should come back, and the inspector is watching for this), no information from profile 23 is necessary. The new profile information is put into inspection device's aircraft profile database 17.

Next, inspector initiates an aircraft inspection event (402). This is accomplished, for example, by inspector 14 pressing a button on inspection device that activates an RFID tag interrogation routine, or otherwise signaling to the inspection device that an inspection is to begin. Inspector then begins discreet inspection events by pressing a trigger on inspection device 10 when the device is aimed suitably at an aircraft seat or row of seats or other target area (403). Data comes back from the RFID tag affixed to a life vest or a life vest's packaging, and is received by inspection device 10 (404). The inspection database 22 is updated with this information, along with any other information on the tag itself (such as the date the life vest was placed in service or the expiration date of the life vest) (405). Validation and exception generation module 28 updates inspection device aircraft profile database 17 with the life vests that have been inventoried, and for example whether the life vest is expired. Validation and exception generation module 28 then requests user interface module 12 to update the user interface with this new set of information. In this way, feedback is presented to the user concerning the state of the inspection. At any point, inspector 14 may signal to inspection device 10 that the inspection is complete (406). Until then, the process loops back to the interrogation of life vest RFID tags (403) until the entire aircraft has been inspected. In another embodiment, it is not necessary to initiate discreet inspection events associated with aircraft rows or other areas. Rather, the inspection event is started for the entire aircraft, and a user moves through the aircraft with the inspection device constantly emitting an RF signal, and the inspection device noting any information read from RFID tags.

When inspector 14 indicates the inspection is complete (406), an exception report is generated (407) which inspector 14 or another person follows-up upon (408). The exception report shows life vests that require further inspection or analysis. If different life vests are put under seats, this information is updated in the aircraft profile, and expected location information possibly written to the RFID tag itself. The profile, updated to reflect the life vest configuration of the just-inspected aircraft, is then sent back to host system aircraft profile database 20, which synchronizes any updates (409). At this point, an inspection is complete. On implementations that do not rely on a centralized host system aircraft database, the profile information, in one embodiment, would be updated into an updated profile within the inspection device.

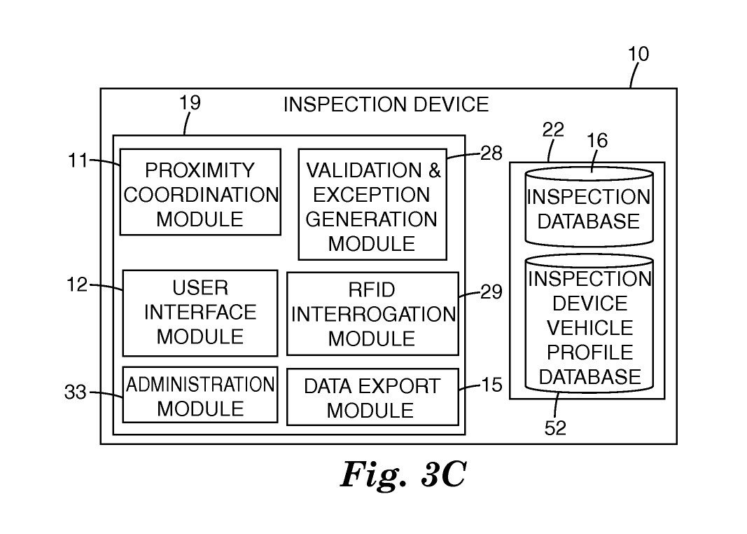

FIG. 5 is a flowchart illustrating another example process for inspection of an aircraft for missing, moved, or expired life vests. The example inspection detailed in FIG. 5 differs from the inspection detailed in FIG. 4 in that the inspection in FIG. 5 uses inspection device location information at the time of an inspection event. This may allow for automatic determination of whether a life vest has been moved, which may be indicative of tampering, thus warranting follow-up by inspector 14.

The inspection starts with the retrieval of an aircraft profile from host system aircraft profile database 20 (501). Alternatively, the aircraft profile may already be on in the memory of the inspection device, or may be otherwise acquired, as, for example, by interrogating an RFID tag that holds the aircraft profile. The profile may only be a subset of the entire profile —ideally it need only define the seating configuration of the aircraft, contain a graphic rendering of the aircraft (or contain enough information such that a graphic rendering could be done by user interface module 12), and include expected location information for each RFID tag-associated life vest on the aircraft (if such expected location information is not already present on the RFID tag itself). Receiving a profile at the start of an inspection is not necessary, and the system accommodates the possibility that a profile simply isn't available. There are several ways to proceed with an inspection in the absence of an aircraft profile. For example, if expected information location for a life vest is already on the RFID tag, the profile is not critical. Alternatively, expected state information is supplied by inspector 14 (when inspecting a row of three seats, inspector 14 makes sure three life vest “pings” come back from an interrogation) and no information from profile 23 is necessary. Alternatively, an inspector could query seats and subsequently compare to profile information to determine exceptions (expired, missing, or moved life vests).

Next, inspector initiates an aircraft inspection event (502). This is accomplished, for example, by inspector 14 pressing a button on inspection device 10 to activate an RFID interrogation routine. Inspector then begins inspection events by pressing a trigger on inspection device 10 when the device is aimed suitably at an aircraft seat or row of seats or target area (503). Data is received from the RFID tag affixed to a life vest or a life vest's packaging, and is processed by inspection device 10 (504). Device 10 updates the inspection database 22 with this information, along with any other information on the tag itself (such as the date the life vest was placed in service or the expiration date of the life vest).

Next, location information of inspection device 10 at the time of inspection is determined (505). Inspection device location information is determined by proximity coordination module 11, where the inspection device location information is derived from external data feeds. Alternatively, inspection device location information could be derived from a defined inspection protocol followed by inspector 14, as discussed above. When inspection device location information is based on a defined inspection protocol, it does not come from proximity coordination module 11, and instead is deduced within validation and exception generation module 28.

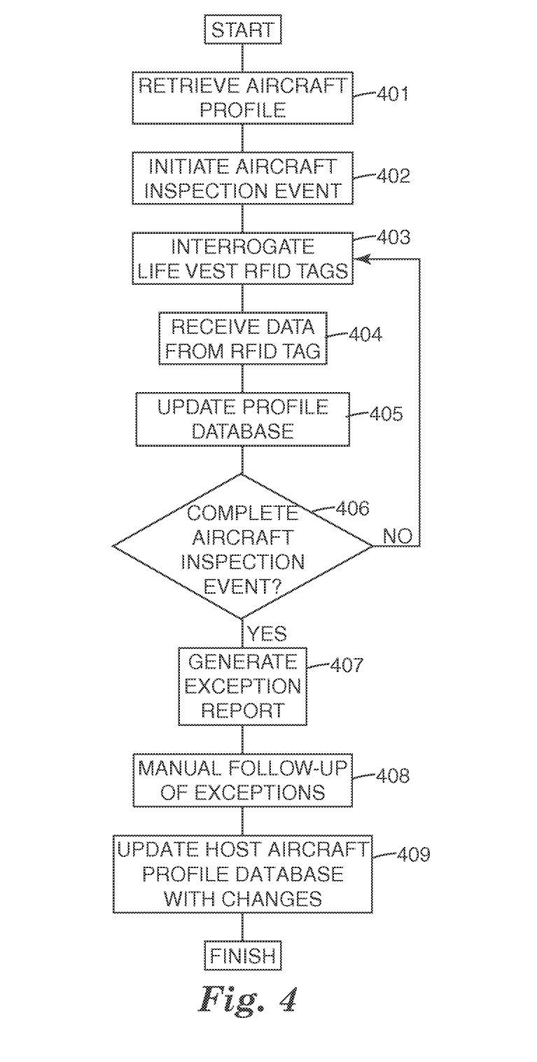

There are several approaches to determining the inspection device's location information at the time of an inspection: by protocol (discussed previously), by the use of proximity tags, or by heuristic data modeling techniques. Each of these approaches is considered in more detail in upcoming discussion with respect to FIGS. 6A, 6B, and 6C.

The inspection device location information is used by validation and exception generation module 28 to determine various characteristics of an inspection event. These various characteristics comprise expected state information for an inspection event, discussed earlier. The specific constituent data elements of expected state information is a function of what is available to compare expected state information against in order to derive meaningful information for inspector 14. For example, if the aircraft subject to inspection contains life vests for which expected location data is available (say for example, life vests # 43, 25, and 58 are positioned beneath a row of three seats, which seat numbers are 34A, 34B, and 34C), the expected state information would include the life vest numbers (43, 25, and 58) for the row. It would not necessarily include expected seat numbers, nor would it necessarily include the row number, as neither of these things could be validated. If, however, seat numbers or row numbers can be validated with an acceptable level of certainty at the time of inspection, then this data would be part of the expected state information. Validation and exception generation module forms its expected state largely from information held within the aircraft profile held in inspection device aircraft profile database 17, and particularly the data sets within the aircraft profile 23 that define the locations where life vests are expected. Expected state information also includes life vest expiration date information, in the form of an expiration date, or the date in which the life vest was placed in service.

Ultimately, validation and exception generation module 28 uses what data it has available and forms a data set that represents the expected state of the subject of an inspection event (an inspection event would be, as mentioned earlier, for example, the interrogation of a row). The actual data that comes back from an RFID interrogation event, carried out by RFID interrogation module 29 and placed in inspection database 16, is then accessed. A comparison is made between an inspection event's expected state, and its actual state. Matches and mismatches are noted in the inspection device aircraft profile database 17 (506).

Validation and exception generation module 28 may then request user interface module 12 to update the user interface with the new set of information in inspection device aircraft profile database 17. In this way, feedback is presented to the user concerning the state of the inspection. At any point, inspector 14 may signal to inspection device 10 that the inspection is complete (507). But until then, the process loops back to interrogation of the life vest RFID tags (503) until the entire aircraft has been inspected or the user indicates the inspection event is complete (“yes” at 507).

When inspector 14 indicates the inspection is complete (or the device indicates the inspection is complete) (yes at 507), an exception report is generated (508) which inspector 14 or others follow-up upon (509). The exception report shows life vests that require further inspection or analysis. If different life vests are put under seats, this information is updated in the aircraft profile, and expected location information possibly written to the RFID tag itself. The profile, updated to reflect the life vest configuration of the just-inspected aircraft, is then sent back to host system aircraft profile database 20, which synchronizes the updates (510). At this point, an inspection is complete.

FIG. 6A through 6C are flow charts illustrating example sub-routines that could be used to determine location of inspection device in step 505 in FIG. 5. The first, illustrated in FIG. 6A, is to use a defined inspection protocol that is followed by user 14. For example, a defined inspection protocol could be that inspector 14 first scans a first row, then a second row, and so forth. In such an inspection, the inspection device location information can be ascertained by inspection device 10 by looking up an internal representation of the protocol (6A1). The protocol may be defined on a one-aisle plane such that user 14 first uses inspection device 10 to first inspect (interrogate) the starboard side of the aircraft, then the port side, then move on to row two and so forth. If there is more than one aisle on the aircraft, such that there is a row of seats in the middle, this would be further defined by the protocol. In this manner, when protocol instructs an inspection of row 36, information received back is presumed to be from row 36. Based on the inspection protocol being followed, the handheld device may be able to ascertain its location on the aircraft. In one embodiment, a plurality of inspection protocols are contained within inspection device and inspector 14 may select among the protocols before starting an inspection. For example, inspector 14 may choose among two protocols, one whereby the aircraft is inspected starting in the rear of the aircraft, and another whereby the aircraft is inspected starting in the front of the aircraft. When following a defined protocol inspection, and interrogating row-by-row, a list of all life vest tags read, and not just those tags in the currently-interrogated row, may be maintained within inspection device 10, along with the location of inspection device 10 as determined by protocol. Additional data may also be stored within inspection device 10, including for example the level of the radio frequency transmit power that was used to successfully interrogate the tag (in certain embodiments the signal strength may be varied during an interrogation event—for example the radio frequency signal strength increased during an interrogation event). At intermediate points in the process of the inspection, or perhaps more typically at the end of an inspection (defined inspection protocol is complete), or even real-time, the data collected may be processed with an algorithm executing on inspection device 10, or the data off-loaded to another computing system and similarly analyzed. The algorithm would, in one embodiment, determine the probable location of each life vest successfully interrogated. For example, the algorithm may be programmed such that if a particular life vest was originally installed in row 13, and the life vest responded to interrogations of rows 12, 13, and 14, the probability is high that the life vest currently resides in its original, and correct, location. One skilled in the art will recognize that embodiments of this approach to scanning could similarly be implemented in the absence of data defining where life vests are located on an aircraft. In such a scenario, an inspection may still be able to determine, with acceptable accuracy, that there are likely enough life vests on an aircraft to meet requirements, and/or that there are a correct number and distribution of life vests, by row or section, for example, on the aircraft. Alternatively, the protocol could be specified by the user 14 such that user 14 specifies to inspection device 10 the row user 14 is going to inspect or has just inspected.

FIG. 6B is a flow chart illustrating a method to determine location information of inspection device 10 by interrogating a positional RFID tag associated with, for example, a row of an aircraft (6B1). This information may be the row itself, or it may be a unique identifier of a row, which must then be looked up in a database to determine the actual row number. Ultimately, however, the row is determined (6B2). One of ordinary skill in the art will recognize that other tags, or identifiers, could be used to convey information concerning an interrogation. For example, bar codes could be placed in proximity to every expected RFID inspection location on an aircraft, and the bar code could be scanned at the same time, or just before or after a row of seats is inspected with RFID inspection device 10. For example, an RFID tag could be placed on every row of the aircraft, and when interrogated, respond with the row number it is within. In this manner, when row 36 is inspected by inspection device 10, the RFID tag defining the row responds that the row is indeed the 36^{th} along with any life vest RFID tags.

FIG. 6C is a flow chart illustrating a method of determining inspection device location information via a heuristic data analysis technique. A heuristic data analysis technique in this context does not rely on location markers or other information specifically identifying the location of an inspection device at the point of an inspection. Rather, heuristic data analysis techniques analyze the data that has been gathered and tries to estimate where the inspection device likely is located. A simple heuristic data technique is described and shown with respect to FIG. 6C. First, data from a life vest inspection event is retrieved and reviewed (6C1). The data is next associated with life vests. For a set of life vests identified per the life vest inspection event, a first life vest RFID tag is assessed to determine where its expected location information says it should be (6C2). This location is presumed to be correct (6C3). The process is repeated for each life vest identified in the life vest inspection event. If any life vest indicates it should be in a different row or location, the entire row may be marked as suspect, and then flagged for subsequent follow-up to confirm whether there is an actual issue.

Other heuristic data analysis methods could be used to determine inspection device location information at the point of inspection. For example, a sliding window technique could be employed where a set of sequential identifiers (N), read from the life vest's RFID tags, are compared using a best-fit pattern match to the ordered set of identifiers within the database. The set of N recently read identifiers is “slide” through the database until the best matching position for the window is determined, thereby providing an indication of the current location of the inspection device.

In other embodiments, combinations of protocol, location markers, and heuristic techniques may be combined. For example, in one embodiment, an RFID device is initially positioned in the aircraft at a given location. A marker tag there is scanned, providing the RFID inspection device with initial coordinates within the aircraft. Inspection device then uses other techniques (protocol or heuristic or inertial) to determine where the inspection device is in relation to the marker tag.

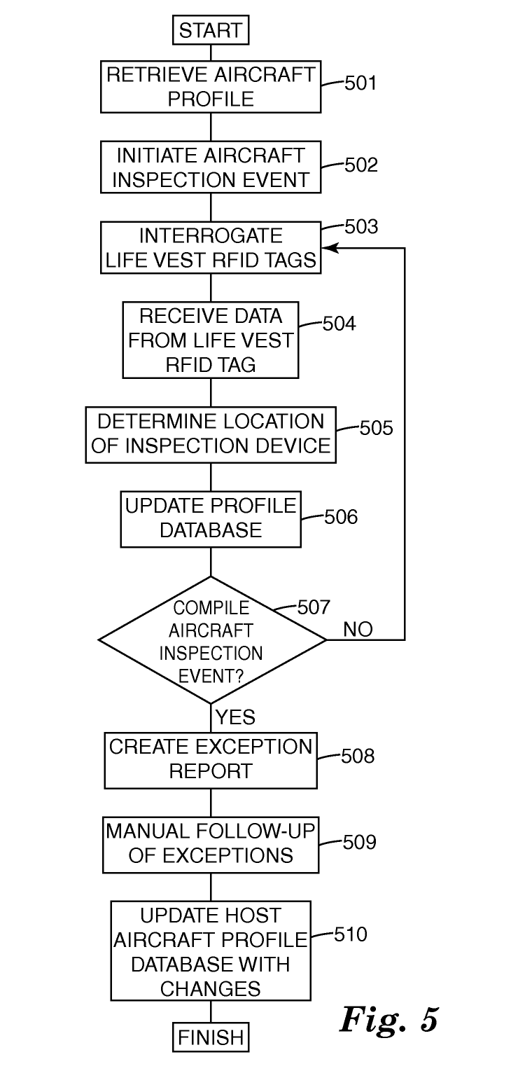

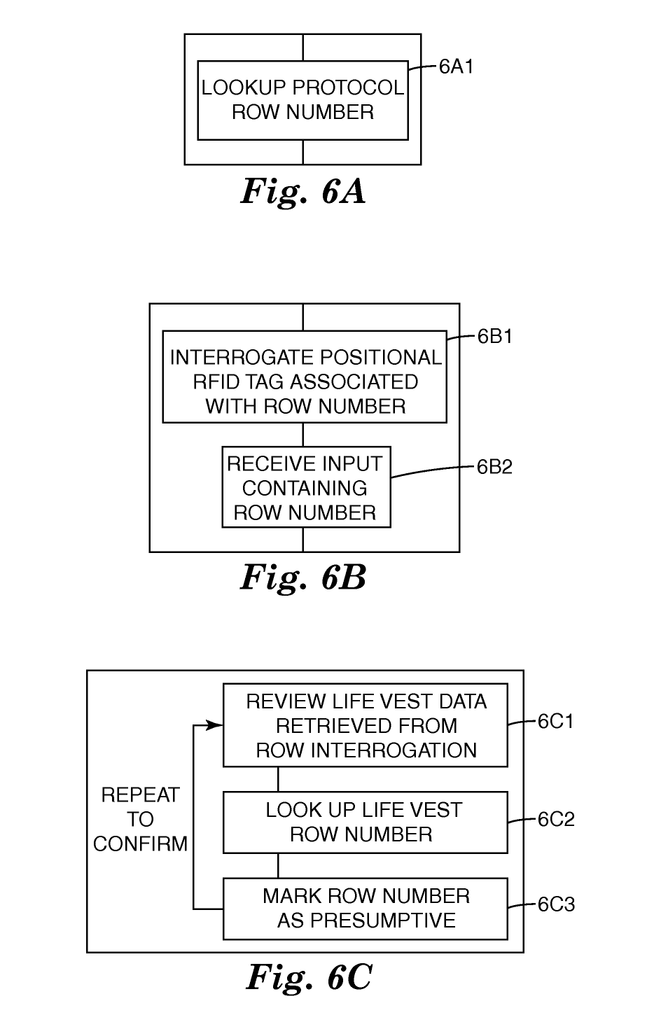

An inspection of an aircraft for life vests may, in one or more embodiments, be aided with an inspection device 10 executing life vest inspection code in the form of a computer program. Inspection device 10, in one embodiment, contains software including user interface module 12, that may generate various graphic user interfaces on screen 3 that assist inspector 14 in inspecting life vests 13 on an aircraft. FIG. 7 shows example information contained within aircraft profile 23 about the aircraft subject to inspection, which inspection device 10 may utilize to graphically render all or a portion thereof on screen 3. Particularly, a seating arrangement is provided as part of the profile. For example, the seating arrangement can be used by inspection device 10 to show example seat number 291 is located in a particular location on the aircraft. FIG. 8 is an example user interface showing display window 3000. Display window 3000 shows a series of visual indicia, in the form of small squares or rectangles, each corresponding to a seat on the aircraft that is being inspected. The individual squares correspond to seats on the aircraft, such as seat 3001 corresponds in this instance to seat 1A. The visual indicia are initially set to a first color, such as gray, that indicates that inspection device 10 has received no information to determine a particular life vest has been accounted for. The inspection is done with inspection device 10 by rows or partial rows. For example, row 3002 may be interrogated in two halves. Though FIG. 8 only shows a few rows of an aircraft, each expected life vest on the aircraft may have corresponding visual indicia within the graphic user interface, and the visual indicia may correspond to more than seat numbers. For example, various locations on a plane may have spare life vests, or may contain special life vests, such as for children. These locations are not generally under aircraft seats. These and other locations would be similarly represented in the user interface, and visual indicia would similarly indicate the expected presence of a life vest in these other locations.

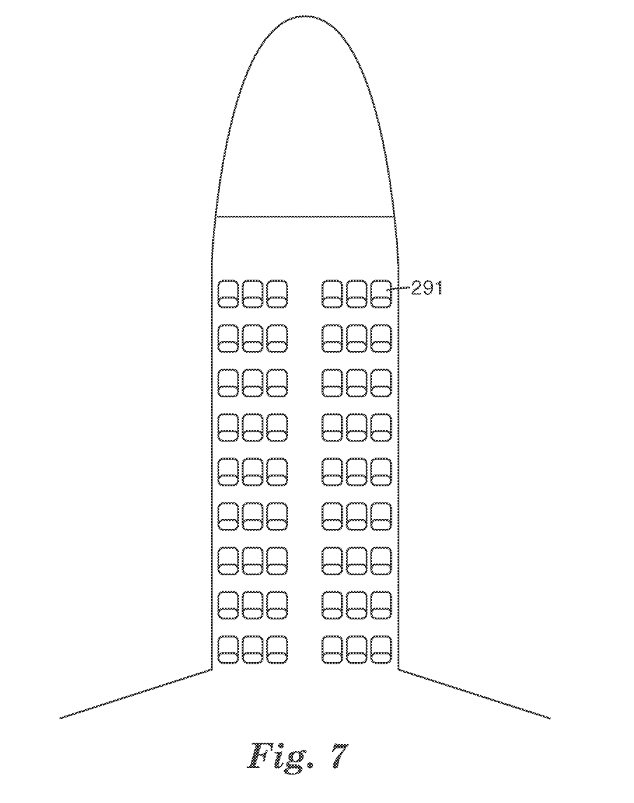

While making the aircraft life vest inspection, inspector may interrogate rows or other locations where life vests are expected, visual indicia representing the locations of life vests on the aircraft as displayed on screen 3 may be updated to reflect the presence of the RFID tag associated with a particular life vest. FIG. 9 shows an example screen rendering wherein a visual indicium 3102, associated with seat 1A on the aircraft, has been updated to reflect the presence of an RFID tag associated with a life vest. In FIG. 9, the visual indicium is a light hash mark. In one embodiment, the visual indicium is the color green. Inspector 14 may quickly and easily look at inspection device 10's display screen 3 to see the various life vests that have presumptively been located. A second type of visual indicia may be used for instances where the life vest is located, but is expired. Expired life vest visual indicium 3101 may be, for instance, the color yellow.

While inspecting the aircraft, inspector 14 may receive output from display screen 3 of inspection device 10 and quickly determine which visual indicia are either red (no RFID tag corresponding to the life vest has been detected), or yellow (RFID tag corresponding to the life vest having been located, but being expired or otherwise requiring follow-up (for example, the life vest may not be in the correct location, or the life vest has been tampered with)).

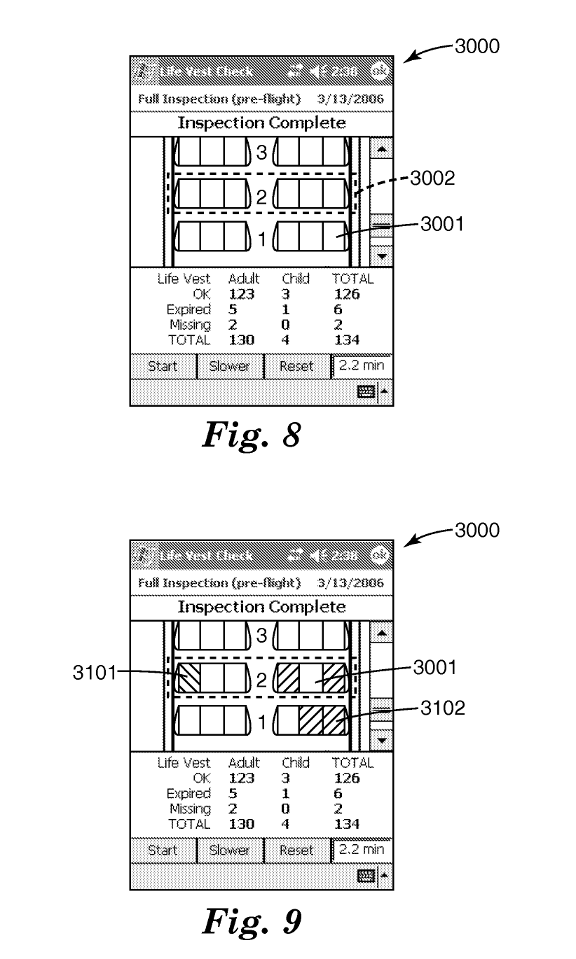

FIG. 10 shows a rendering of an example screenshot that shows how the screen scrolls as the inspector makes his or her way through the aircraft. Particularly, FIG. 10 is an example screen rendering a few seconds after the rendering of FIG. 9, after inspector has moved closer to row 3204. Seat 3102 is now partially obfuscated by the border of the display window, and the new row 3204 is beginning to appear at the top of the window. User interface module 12 provides a scrolling view of the aircraft and the inspection device's location within the aircraft by updating display window 3000 whenever new information regarding a change in the location of inspection device 10 is available to user interface module 12. User interface module 12 attempts to render display window 3000 such that the next row to be interrogated is slightly above the middle of display window 3000.

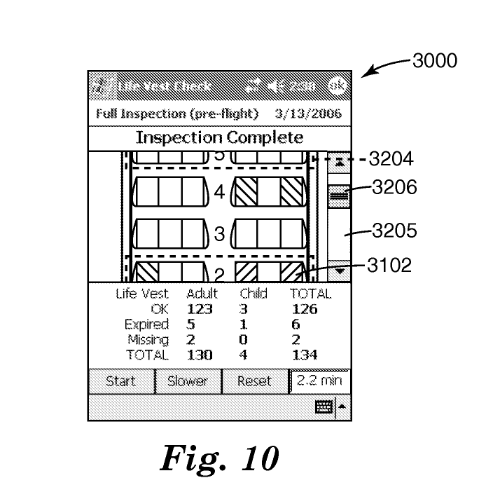

FIG. 11 is a flowchart showing an example process to update visual indicia representing locations of expected life vests in user interface window 3000. Initially, user interface module 12 renders a graphic representation of the aircraft, including at least enough detail to distinguish discreet areas in which a life vest may be expected to reside (3301). In other words, the graphic representation need not be overly detailed, but it must at least show all of the places on an aircraft where life vests would traditionally be stored or located.

Next, user interface module 12 associates a visual indicium with each expected location of a life vest (3302). The expected locations of life vests may come from a database pre-loaded with information about specific life vests located in discreet locations. This database would be loaded into inspection device aircraft profile database 17 as part of the aircraft profile 23, described above. Alternatively, if this information is not available, user interface module 12 uses a default mapping of life vests within the aircraft that defines the minimum life vest configuration necessary for the aircraft to make a flight. Additionally, default layouts of most aircraft, in the form of partial profiles, may be stored within the inspection device 10. Thus, if no detailed information about a given aircraft were available as part of its profile, user interface module 12 would assign a visual indicium to each seat in the aircraft, as defined by the default aircraft profile.

At this point, user interface module 12 is ready for an inspection to begin. Inspector 14 may begin interrogating RFID tags 15 associated with life vests 13 (3303). Information that comes back from an RFID interrogation at minimum includes a unique identifier, and may additionally include the RFID tag's last-registered location (for example the seat number that the life vest was last registered under). If the location information is not included in the set of information that comes back from the RFID tag, this positional information may be contained within inspection device aircraft profile database 17, and thereby cross-referenced. There are other techniques, described in greater detail above, that could be used to determine either the actual or expected location of a life vest (for example, via inspection protocol, via a separate RFID tag that includes location information, or via heuristic methods). No matter the details of a particular technique (those skilled in the art may appreciate myriad techniques), proximity coordination module 11, in one embodiment, determines the expected location of the interrogated life vest 13 RFID tag 15, and passes this location information to user interface module 12 (3304) via inspection device aircraft profile database 17. The location may either be the expected location of the life vest, or it may be the actual location of the life vest, or it may be both. In one embodiment, it is both, which allows for the identification of an exception condition wherein the life vest is present, but is out of place. In an embodiment already described, and as will be used for the illustrative purposes of this example, the location information is merely the expected position of the life vest, contained within a life vest's RFID tag, in the form of a seat number. The expected position of the life vest would have been registered on the tag when the life vest was placed under a particular seat. For purposes of illustration, let us presume the information received from the tag interrogation (3303) and the location determination (3304) revealed the tag was #58237, and its expected position is under seat 7B. Validation and exception generation module 28 determines a code for the given seat for which information is available. The code defines the inspection status of life vest. In one embodiment, the codes are as follows:

TABLE 1

| Life Vest Inspection Code | Meaning |
|---|---|
| 1 | RFID tag associated with life vest |
| | responded without incident. |
| 2 | RFID tag associated with life vest |
| | responded, but indicates the tag is expired. |
| 3 | RFID tag associated with life vest |
| | responded, but expected location does not |
| | equal actual location. |

As will be evident to one skilled in the art, the use of life vest condition codes other than 1 is dependant on the availability of data to support these codes. The non-existence of data to support life vest condition codes 2 or 3 does not obviate the need or value of doing an inspection that only reveals life vest condition code 1s. However, life vest condition codes 2 and 3 provide a more thorough inspection, and have supporting processes described elsewhere in this specification. Preferred embodiments gather enough data to support all inspection codes. Validation and exception generation module 28 passes the location code, 7B, along with a condition code, in this case 1, indicating the life vest was found, to user interface module 12, via inspection device aircraft profile database 17, which updates the visual indicium associated with seat 7B to be, in this case, from gray to green (3305). Other indicia useful to the user could be used alternatively or in combination with a color change. For example, an auditory signal could be sent when a life vest was properly located, and a different auditory signal sent when a condition other than that represented by code 1 was sent (everything but code 1 requires follow-up by inspector 14 or another authorized person, so an auditory indicium, such as a beep, may indicate required follow-up).

The interrogation/inspection portion of the process is repeated (3306) until inspector 14 indicates the aircraft life vest inspection is complete, or all life vests that are expected have been accounted for, at which point the inspection is stopped (3307).

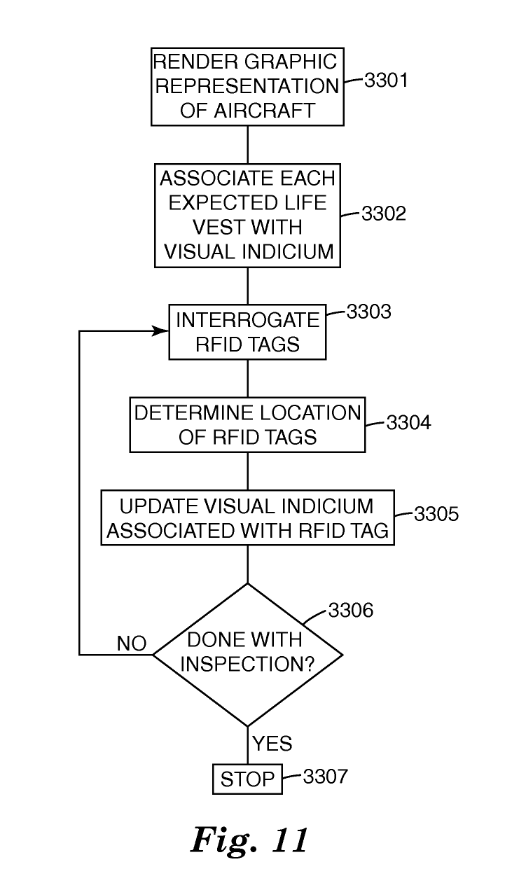

FIG. 12 is a flowchart showing an example operation of another aspect of display window 3000, namely the manner in which its graphic representation of the interior of the aircraft scrolls as user 14 moves inspection device 10 within the aircraft, and as further represented in FIG. 10. The scrolling functionality is produced by first rendering a graphic representation of the aircraft (3401), the same as described in regard to FIG. 11. Next, each expected life vest is associated with a visual indicium within the graphic representation (3402), again the same as with regard to FIG. 11. Next, the graphic representation and its corresponding visual indicia are rendered onto the screen along with scroll bar 3205, with an initial position at the front of the aircraft (3403). The length of the scrollbar corresponds to the length of the graphic representation of the aircraft, which corresponds to the aircraft itself. User 14 may move box 3206 along scroll bar 3205 to inspect the graphic representation of the aircraft, and more particularly the status of visual indicium associated with each life vest 13 on the aircraft.

Next, inspection device 10 may determine its location within the aircraft (3404). As mentioned above, there are several methods to ascertain this positional information. Some include the use of an inspection protocol, the use of positional RFID tags located at various positions throughout the aircraft, and the use of heuristic data modeling techniques that determine the supposed position of the interrogation device based on the life vest RFID tags being interrogated, and perhaps the order of the interrogation.

Inspection device location information is sent to user interface module 12, which renders a new display window 3000 wherein the row just interrogated is positioned slightly below midpoint of the Y-axis of screen 3, and the next row anticipated to be interrogated is positioned just above the midpoint of the Y-axis of screen 3 (3405). These last two steps are repeated via the “done with inspection” check (3406) whenever new information describing the location of inspection device 10 is available, and in one embodiment, after each discreet inspection event. When the “done with inspection” check (3406) is true, the inspection may be complete (3407).

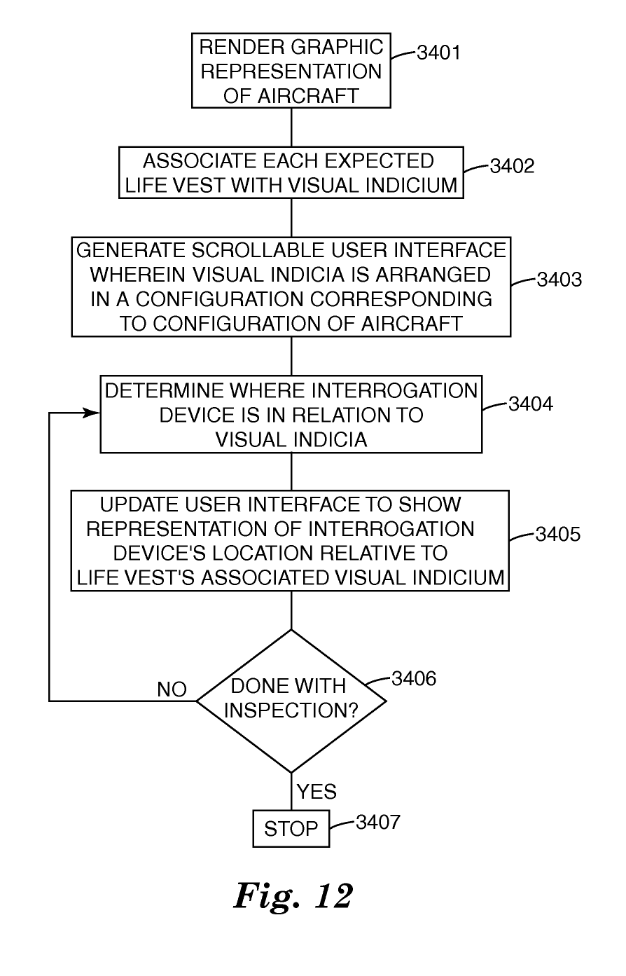

If an aircraft profile containing the aircraft's seating configuration is not available, in one embodiment, inspection device 10 presents inspector 14 with a series of questions that allow inspector 14 to define the aircraft's seating position in an ad hoc manner. The inspector is presented with a series of questions, such as the number of rows, the number of aisles, the number of seats in a row, and so forth. There is then a dialog allowing the addition of alternative locations for life vests not associated with the seating arrangement (such as spare life vests and child life vests). FIG. 13 is a flow chart representing an example manner in which the construction of aircraft profile, graphically driven by user interface module 12, could work.

First, inspector 14 initiates configuration of a new aircraft event (3501). This would be done, for example, by pressing a button on inspection device 10, or if screen 3 is touch-sensitive, touching a portion of the screen indicating inspector 14's desire to manually configure the aircraft profile. Next, the user is presented with a series of questions: How many rows in the aircraft? (3502); How many aisles in aircraft? (3503); How many rows in a specific class section of the aircraft (class being first class, coach class, etc.)? (3504). The class question (3504) begins an iterative process by which each class is defined, then subsequently information is gathered about that class of seats. The remaining steps 3505 through 3508 encompass this iterative process. Questions about seat configuration (a surrogate for most information about life vest location configuration) continues until inspector 14 indicates there is no further class in the aircraft (3508), at which point inspector 14 is able to add, in an ad hoc manner, other information about where to expect life vests on the aircraft (3509-3512). If there are no further life vests expected on the aircraft, inspector 14 indicates such at 3509, and the aircraft configuration event is completed (3513).

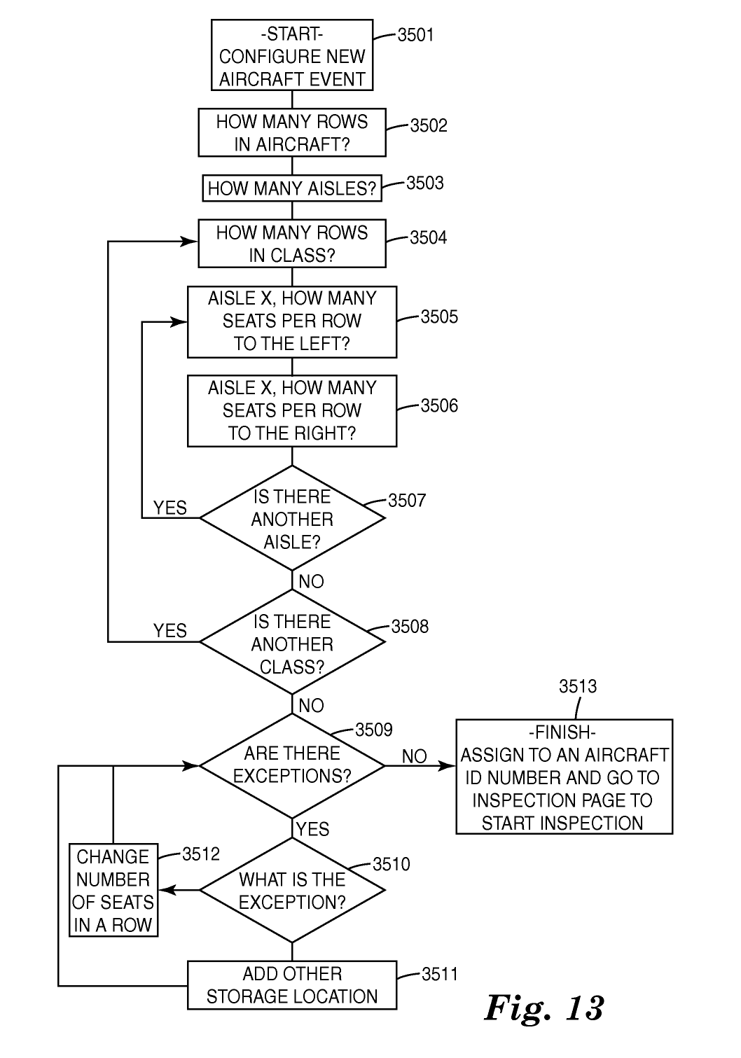

FIG. 14 shows example attachment of RFID tag 15 to life vest 13. In one embodiment, RFID tag 15 is placed on the exterior of life vest 13, as is illustrated by RFID tag 15A. Alternatively, the RFID tag may be place on packaging into which the life vest is stored on an aircraft. Placing an RFID tag on packaging into which the life vest is stored is discussed in greater detail below. In one embodiment, RFID tag 15 is placed on the interior of the life vest, as illustrated by RFID tag 15B, as illustrated in a cutout view (101) of life vest 13.

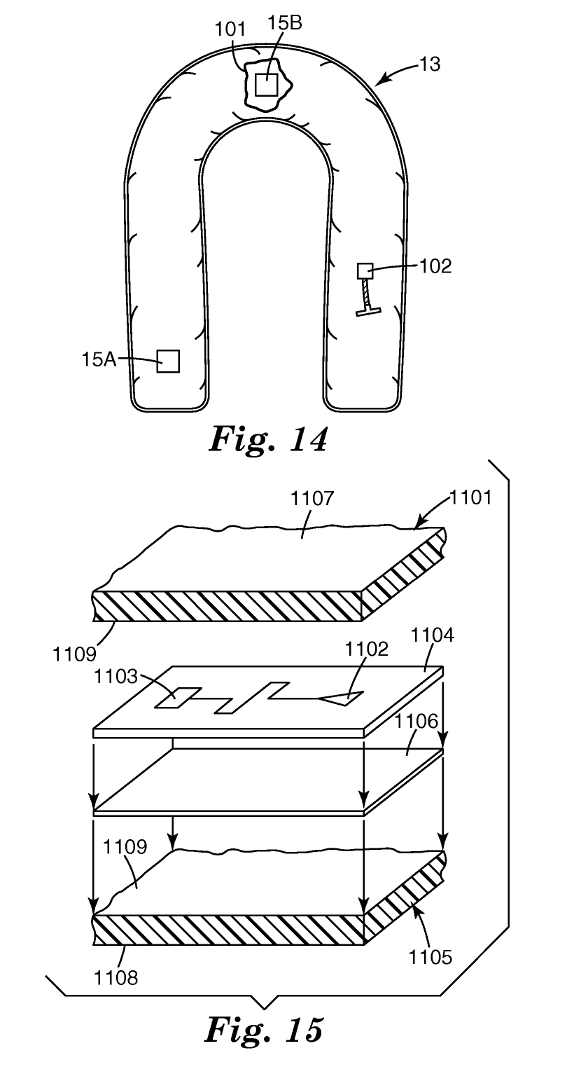

FIG. 15 shows an exemplary view of a life vest 13 cut out. A first and a second membrane (1101 and 1105) represent two layers of material typically used in life vest production. The membranes have an exterior surface (1107 and 1108) as well as an interior surface (1109). The exterior surface is typically nylon. The interior surface is typically a coating of polyurethane (PU). The PU coating usually gives the life vest its substantially waterproof characteristics, while the exterior nylon gives the life vest durability against exposure and abrasion. Flexible circuit substrate 1104 is comprised of an electrically insulating material having a suitable dielectric constant, such as fiberglass or plastic. An electronic circuit 1103, such as an application specific integrated circuit (ASIC) or discrete logic components, is electrically connected to the antenna 1102 disposed on the flexible circuit substrate layer 1104.

There are several ways to ensure the RFID tag is securely within the life vest. Three are discussed herein, but those skilled in the art will recognize several approaches could be employed. One method is to use an adhesive. Adhesive layer 1106 exemplifies this approach. Adhesive layer may include various primers, or it may not be necessary at all if other non-adhesive-based techniques, as described below, are employed.

A first example way to affix an RFID tag to the interior of a life vest includes the use of a particular type of adhesive in adhesive layer 1106, which is designed to work well in the unique operating environment of the interior of the life vest 13.

As mentioned, interior surfaces of life vests typically comprise a coating of polyurethane (PU). PU has a low surface energy, which makes it a difficult surface to adhere to. Conventional acrylic-based adhesives popularly used on RFID devices may not adhere well to PU or other low energy surfaces. Adhesion of RFID tag 15 to the interior PU-based surface 1109 of life vest 13 may be accomplished, however, by using a high performance adhesive designed to work with PU. A preferable adhesive system includes an adhesion promoter such as one known under the trade designation “3M™ Adhesion Promoter 86A” and a pressure sensitive acrylic adhesive transfer tape or acrylic adhesive transfer tape, such as the class of low surface energy laminating adhesives 300 LSE available from 3M™, and specifically adhesives known under the trade designations, “3M™ 9485PC”, “3M™ 9934XL”, or “3M™ 9472E”.

Various adhesives were tested to adhere the RFID label to the interior surface of a life vest. The interior surface of the life vest comprised a thin, continuous, smooth coating of PU. Life vests used for the test were from Eastern Aero Marine, Inc, 5502 NW 37th Avenue, Miami, Fla. 33142, under the trade designation Adult/Child Life preserver, Model UXF-35, FAA-TSO-C13f. The RFID tag used for the tests was purchased from Alien Technology 18222 Butterfield Blvd., Morgan Hill, Calif. 95037, under the trade designation “ALL 9354-02 (M)”. The adhesives used in the tests are available from 3M™ of St. Paul, Minn., under the trade designations specified in Table 2, except for the Alien™ adhesive, which was pre-applied to the Alien RFID tag. The primer used is available from 3M™ of St. Paul, Minn., under the trade designation “3M™ Adhesion Promoter 86A”. The primer layer may also be provided by a variety of resins including but not limited to any hydroxy functional vinyl resin (e.g., VAGH from Union Carbide Corporation of Houston, Tex.), any carboxyl functional resin (e.g., VMCH also from Union Carbide Corp.), or any amine functional resin. Polyamide primer layers such as MACROMELT 6240 from Henkel Corporation of Dusseldorf, Germany, may also be used. These primers are best applied by dissolving in a suitable solvent (e.g., isopropyl alcohol) and wiping onto the area to be adhered. Other ways to prepare the PU surface could be used, including as a non-limiting example, a Corona treatment. Labels were adhered to the inside of the life vests behind the exterior text panel. Labels in this position did not exhibit any degradation in RFID-related performance throughout the testing process. It was clear from initial testing that labels attached to a surface without the use of the primer did not adhere as well as the when the primer was used. This was true for every adhesive tested.

Life vests 13 were tested using the following inflation test to assess how well the adhesives work during real world use. The inflation test is an FAA approved test for life vests and is conducted on life vests every 5 or 10 years, depending on the type of vest. The life vests were pressurized to 2-4 PSI (0.014-0.028 MPa) and held under pressure for 1-2 minutes. Observations were made and the vest then deflated, folded, and packed as they would be in preparing for placement within an aircraft. This process was repeated 5 times, which is typical of the number of life vest test cycles the life vest may undergo in its operational life. All RFID tags functioned after the test. Further, no life vest leaked air after any test. However, RFID tags adhered to the life vest's interior surface without the use of primer detached from the life vest surface and became free-floating within the life vest cavity upon light shaking in some cases, and no shaking in others.

Adhesives were applied to a polyester backing (the same as would be found on an RFID tag), then adhered to the PU surface of one-inch strips of life vest material. Both a 5-minute and a 72-hour, 180-degree room temperature peel test were performed as per ASTM-D3330 test method A on the different adhesive systems mentioned above. Each test was performed three to five times to arrive at an average peel strength value. Table 1 summarizes results of the testing.

TABLE 2

| | | 5 Min Peel Strength, | 72 Hr Peel Strength |
|---|---|---|---|
| Primer | Adhesive | average oz./in. (N/m) | average oz./in. (N/m) |
| No | 3M ™ 8616 | 3 (32.8) | 8 (87.6) |
| No | 3M ™ 8617 | 29 (317.4) | NT* |
| No | 3M ™ 9472LE | 16 (175.1) | 25 (273.6) |
| No | 3M ™ 8672 | 1 (10.9) | 3 (32.8) |
| No | 3M ™ 9485 | 13 (142.3) | 36 (394.0) |
| No | Alien “ALL | 9 (98.5) | 27 (295.5) |
| | 9354-02 (M)” | | |
| No | None | NT* | NT* |
| Yes | 3M ™ 8616 | 31 (339.3) | 53 (580.1) |
| Yes | 3M ™ 8617 | ≧120 (1313.5) | ≧120 (1313.5) |
| Yes | 3M ™ 9472LE | 52 (569.2) | 47 (514.4) |
| Yes | 3M ™ 8672 | 49 (536.3) | 60 (656.7) |
| Yes | 3M ™ 9485 | 49 (536.3) | 64 (700.5) |
| Yes | Alien “ALL | 45 (492.5) | 57 (623.9) |
| | 9354-02 (M)” | | |
| No | Ultrasonic weld | NT* | NT* |

*NT = not tested

A second example way to affix an RFID tag 15 to an interior surface of life vest 13 is by the use of high frequency welding. This was achieved using the following technique. The RFID tag was placed on the inside of the vest and held in position using the adhesive already on the tag as supplied by Alien™. A section of PU-coated nylon fabric two inches larger (overlapping) than the RFID tag in the X and Y direction was then placed centrally over the RFID tag. The section of PU-coated fabric was oriented in such a way that the PU-coated surface of the cover and the PU surface of the vest were adjacent to each other. The assembly was then placed under the HF welding horn of a FIAM Welding machine Model # 3005 LF, manufactured by, FIAB System AB, S-453 29 Lysekil, Sweden. Sufficient energy (power and time) was applied to the horn to weld the PU layers of the two fabrics together. This process was repeated on each of the four sides of the patch, thus enclosing the RFID label in the HF welded patch.

A third example way to affix an RFID tag 15 to an interior surface of life vest 13 is through the use of mechanical fasteners, such as hook and loop, which have been adhered to a surface of the life vest. Refastenable fastening devices of the hook and loop-type are currently used widely in a great number of situations. Such refastenable fastening devices have been used in clothing, disposable articles, and various miscellaneous articles such as safety belts and the like. Such devices are used when it is desirable to create a refastenable bond between two or more articles or between several surfaces of the same article. In certain applications, these refastenable fastening devices have replaced conventional adhesives, buckles, zippers, buttons, snaps, tie fasteners, and sewing.

A popular type of mechanical fastener currently in wide use which utilizes mechanical entanglement to create a refastenable bond is sold under the trademark “VELCRO”. VELCRO fastening devices are described in greater detail in U.S. Pat. No. 2,717,437, U.S. Pat. No. 3,009,235, U.S. Pat. No. 3,266,113, U.S. Pat. No. 3,550,837, U.S. Pat. No. 4,169,303, and U.S. Pat. No. 4,984,339. Other types of mechanical fasteners are described by 3M in U.S. Pat. No. 4,894,060, U.S. Pat. No. 5,870,770, U.S. Pat. No. 5,679,302, U.S. Pat. No. 6,000,106 and U.S. Pat. No. 6,814,912.

Mechanical fasteners utilize two components, a male component and a female component. The male and female components are often referred to as the hook and loop components, respectively. The hook component consists of a fabric which contains a plurality of resilient, upstanding hook-shaped elements. The female component of the fastening device consists of a fabric containing a plurality of upstanding loops on its surface. When the hook component and the loop component are pressed together in a face-to-face relationship to close the fastening device, the hooks entangle the loops forming a plurality of mechanical bonds between the individual hooks and loops. When these bonds have been created, the components will not generally disengage under normal conditions. This is because it is very difficult to separate the components by attempting to disengage all of the hooks at once. However, when a gradual peeling force is applied to the components, disengagement can be easily effected. Under a peeling force, since the hooks are comprised of a resilient material, they will readily open to release the loops.

A fourth example way to locate an RFID tag 15 to an interior surface of life vest 13 is to place the RFID tag inside of the life vest at the time of manufacture, not adhered or otherwise affixed to any interior surface of the life vest. RFID tag 15B would then be free to move around. This free movement would not necessarily pose problems as initial placement and subsequent folding during the manufacturing process may adequately orient the tag. Unfolding of life vest 13 usually does not take place during an inspection process. Rather, the life vest is typically unfolded during a re-certification process, which can happen 5-10 times in the life of the vest. It is possible, however, that a freely moving RFID tag 15B could end up in a position within life vest 13 wherein its ability to send or receive radio signals is diminished or compromised. This might happen, for example, if RFID tag 15B were situated in close proximity to a radio insulation or reflection component, such as life vest inflation mechanism 102. Life vest inflation mechanism 102 typically contains a CO2 cartridge made of metal. This and other components of a life vest may prevent RFID tag 15B from performing as intended. Free movement may be restricted by the creation of an interior compartment, or cavity, within the life vest that restricts the movement of RFID tag 15B.

As mentioned above, an alternative to placing RFID tag 15 on the interior or exterior of life vest 13 is to place it on the life vest packaging. When placed on life vest packaging, the use of a particular type of RFID tag, in a particular configuration, may render the life vest packaging tamper evident and enable remote identification of packages that may have been tampered with. Particularly, an RFID tag placed across the tear path of a package inside of which the life vest has been placed will be destroyed or rendered inoperable when the package is opened.

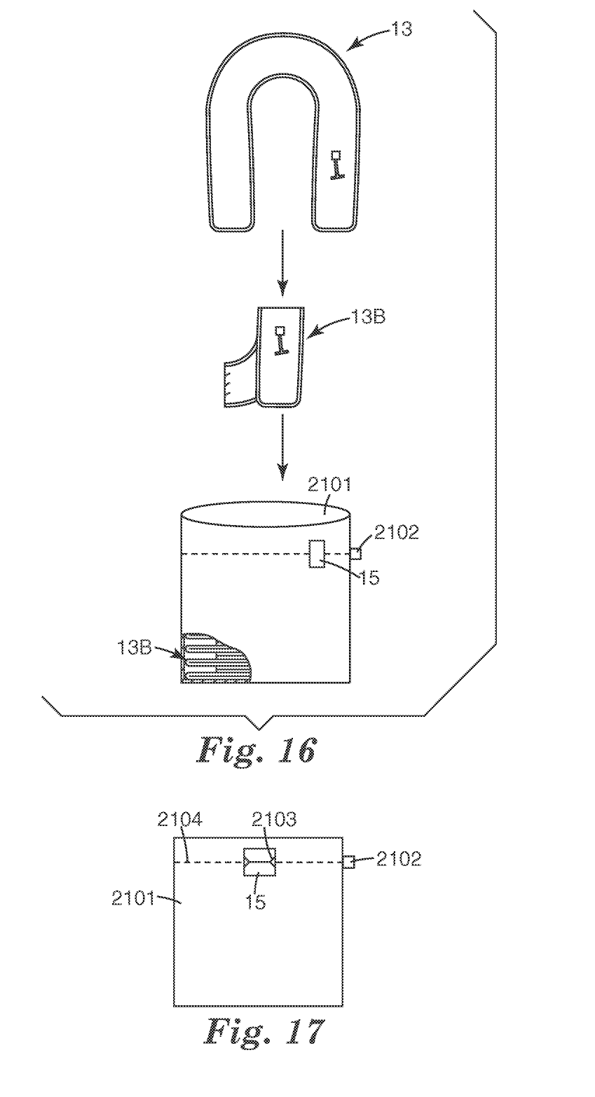

FIG. 16 shows an example configuration of life vest 13, folded (13B) and placed within package 2101. RFID tag 15 is situated on package 2101 in a manner such that it not practical to gain access to the life vest without compromising RFID tag 15. Package 2101 includes tear tag 2102. Not all life vest packaging has such a rip tag. There are generally two types of aircraft life vest packages: 5-year and 10-year. A 5-year package is usually composed of a flexible polymer such as polyethylene, and includes a tear tag, such as tear tag 2102 made of a tear-resistant plastic, which is attached to surface of the package, and the package closed by stitching the surfaces together. Pulling tear tag 2102 opens package 2101 by producing a uniform slit across the package. A 10-year package is usually made from the same material as the life vests: nylon, coated with PU. To assist in opening a 10-year package, a notch is cut into the fabric so a tear can propagate in the desired direction. Package 2101 is a 5-year type, and further life vest package examples presented herein are drawn generally to a 5-year type of package. This focus on a 5-year type package is for illustrative purposes only. As will be appreciated by one skilled in the art, this invention may be easily applied to a 10-year type package, and any existing or to-be-conceived packaging solution that includes a mechanism for accessing the package's contents along a pre-defined region of the package's membrane.

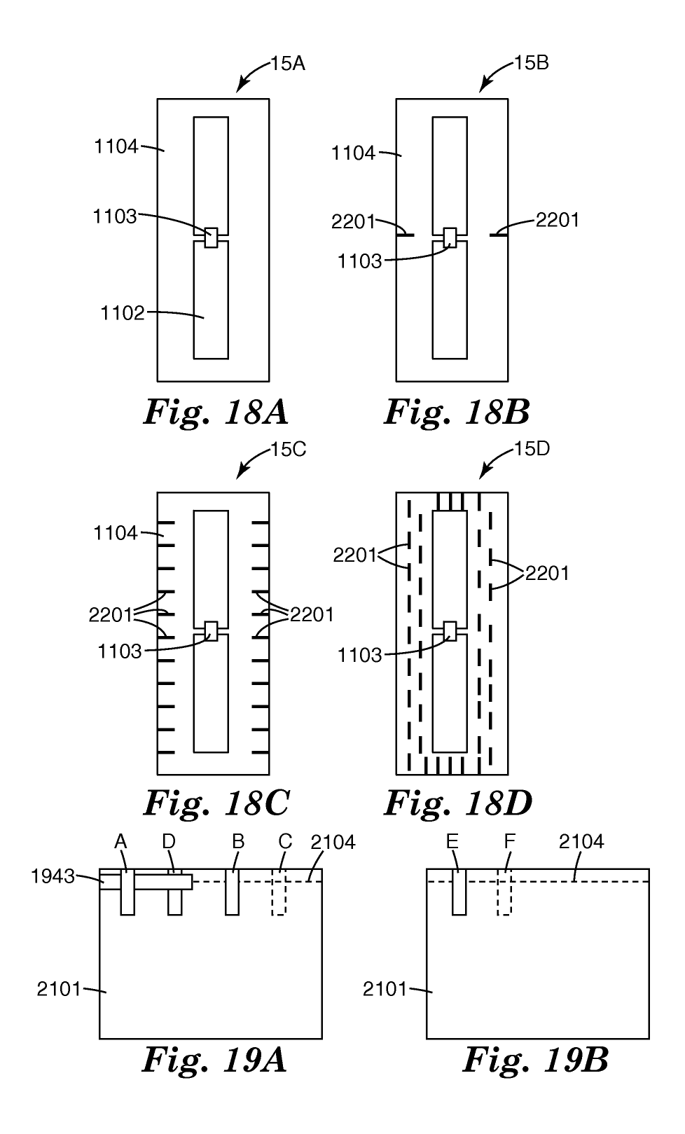

FIG. 17 shows a more detailed view of example package 2101. In particular, RFID tag 15 is shown, and perforation 2103 in RFID tag 15 is situated such that its apex intersects a tear line 2104 that defines an eventual opening line, such that by pulling tear tag 2102, the resulting lateral slit will compromise the RFID tag. The compromise of the RFID tag may take several forms, but in a preferred embodiment, the RFID tag antenna is separated into two parts and thereby rendered inoperable. If using life vest inspection methods described elsewhere in this specification, the inoperative RFID tag would result in the associated life vest being considered missing or compromised, and would compel subsequent follow-up, which would likely mean physical inspection. If the package were found to be compromised, the life vest in the package would be re-packaged (if the life vest was found to be in satisfactory condition). Alternatively, if a package were found to be compromised, then a replacement package containing a life vest would be substituted for the compromised life vest.

The inoperability of the RFID tag, in one embodiment, is the result of the RFID tag's antenna being separated from the RFID tag's integrated circuit. This may be accomplished by situating the RFID tag upon the tear line 2104 in a way such that the slit will either disconnect the RFID tag's antenna, or disconnect a sufficiently large portion of it that the practical result is the same.

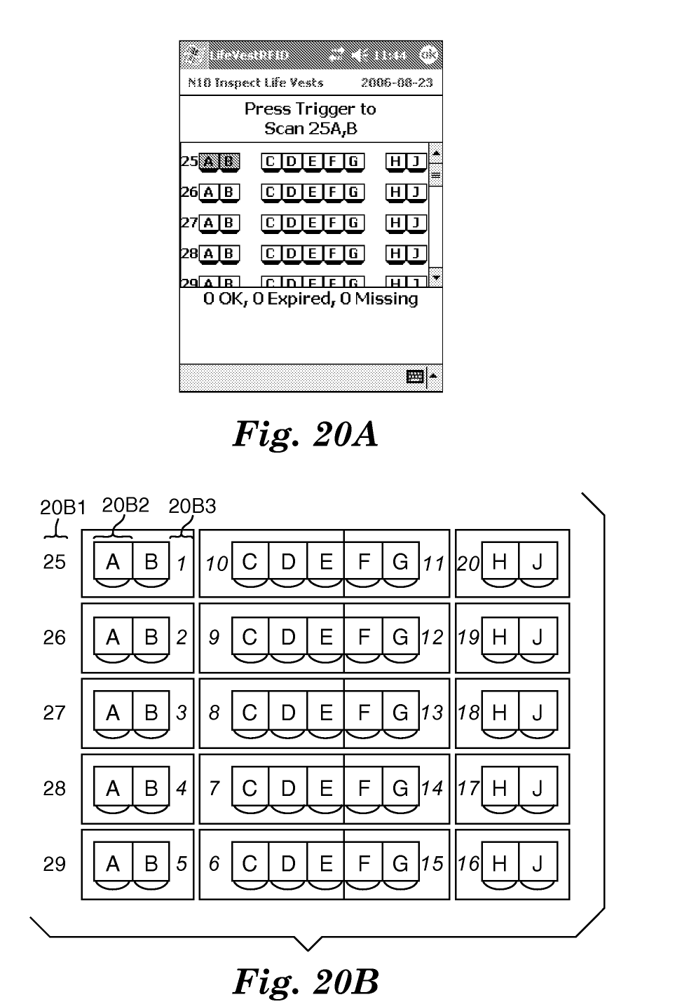

One or more tear propagation points (small slits or holes) in flexible circuit substrate 1104 can significantly enhance the sensitivity of the RFID tag to compromise. FIG. 18A through 18D show examples of pre-slitting flexible circuit substrate 1104. RFID tag 15A shows flexible circuit substrate 1104 without any tear propagation points. It includes antenna 1102 and integrated circuit 1103. Antenna 1102 and integrated circuit 1103 repeat in example views of RFID tags 15B, 15C, and 15D, but for clarity they are not explicitly specified with respect to the figure. RFID tag 15B shows flexible circuit substrate 1104 with two lateral notches or slits, 2201, that, when connected, intersect integrated circuit 1103 at approximately a 90 degree angle. A tear down this slit would compromise the RFID device by destroying the integrated circuit antenna interface. RFID tag 15C shows tear propagation points, in this case slits 2201, variously positioned along a first edge of flexible circuit substrate 1104, with a similarly situated set of slits positioned along the flexible circuit substrate's second edge. The slits do not need to be aligned, and there need not be slits on both edges—the slit is of particular use on the edge closest to the start of the tear propagation point. Putting slits on both edges makes application of the tags less error-prone (there are multiple orientations that will work). A tear across any of these slits would compromise the antenna. For some RFID tags, the compromise of the antenna will render the RFID device inoperable. For other RFID devices, the device may still work, but work differently. For such RFID devices that are not rendered inoperable merely due to antenna compromise, the integrated circuit is designed such that it will not function if any antenna circuit is broken. RFID tag 15D shows an alternative configuration of the slits, such that they run substantially parallel to the longer axis of RFID tag.

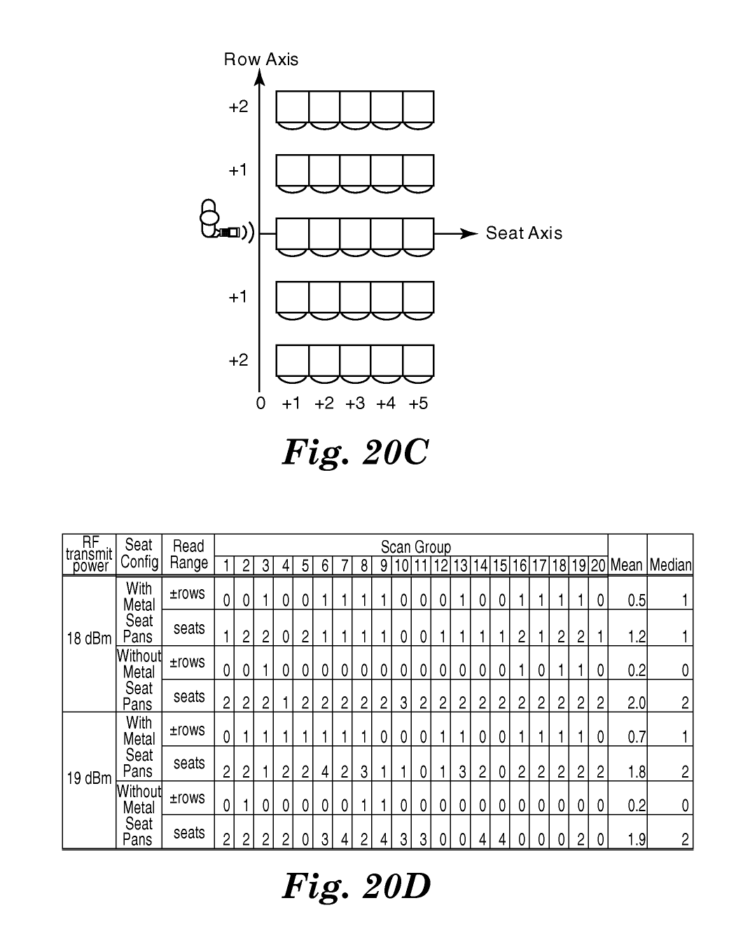

915 MHz Alien™ (of Morgan Hill, Calif.) Squiggle™ ALL-9338-02 EPC RFID tags were used in testing various tear propagation points, or slit configurations. RFID tags were attached to five and ten year packages using a pressure sensitive adhesive that came on the RFID tag, and an adhesion promoter (3M™ A86, mentioned above) if needed. FIG. 19A and 19B show various placement positions of RFID tags on life vest packages. Specifically, FIG. 19A shows placement on a five year vest, and FIG. 19B shows placement on a ten year vest. On the five year vests (FIG. 19A), the tags were placed as follows: A—on the exterior surface of the package across the tear line (2104), on top of the stitched on tear label 1943 (such tear labels allow a user to grip a member that facilitates the tear in the tear propagation line 2104, and is available on certain life vest packages); B—on the outside of the package on top of the stitched tear line (2104), away from the stitched tear label 1943; C—placed on an interior surface of the package before it is stitched together, located on the tear propagation line 2104; D—placed on the outside of the package, but underneath the tear label 1943. On the ten year vests (FIG. 19B), the tags were placed as follows: E—on the exterior of the package across the tear line 2104; F—placed on the interior of the package before the package is sealed via high frequency (HF) weld. Testing of RFID tags on life vest packages involved first putting slits on the RFID tag's flexible circuit substrate 1104 (if needed). Second, the RFID tag was placed on the life vest package such that a pair of slits approximately aligned with tear line 2104. The specific mechanism of attaching is described earlier, but in all cases the attachment mechanism was sufficiently strong as to hold the RFID tag in place throughout the testing. Third, the RFID tag was tested to ensure it operated properly, and was readable after attachment to the package but before opening the bag. Fourth, the package was opened along tear line 2104 using the appropriate mechanism (either tear tag 2102 or a tear notch). The RFID tag test passed if, upon package opening, the RFID tag was compromised and thereby rendered inoperable. Table 3 shows the results of the testing.

TABLE 3

| | Location | Slit | Vest | Opening |
|---|---|---|---|---|
| | (see FIG. 19A | ((Y)es/ | operating | rendered tag |
| Test ID | and 19B) | (N)o) | life (yrs) | inoperative |
| AAMD-1 | E | Y | 10 | True |
| AAMD-2 | E | N | 10 | False |
| AAMD-3 | E | N | 10 | False |
| AAMD-4 | F | Y | 10 | True |
| AAMD-5 | A | Y | 5 | True |
| AAMD-6 | C | Y | 5 | True |
| AAMD-7 | B | Y | 5 | True |
| AAMD-8 | D | Y | 5 | True |
| AAMD-9 | B | N | 5 | True |

Most configurations passed the test (that is, the RFID tag was not readable after opening the bag, which is indicated by a “true” in the last column of Table 3). Three tests did not use a pre-slit RFID tag. The first, AAMD-2, used an adhesive that was later determined to be poorly suited for the application. AAMD-3 used 3M™ PSA 8617 with the surface treated with 3M primer A86 (described further above). The RFID tag adhered well to the surface and did not allow the package to be opened by normal forces at the tag across tear line 2104. With no slits, the tear strength of the RFID tag (with a polyester backing) was sufficiently high such that either the adhesive failed before the RFID tag's flexible circuit substrate was compromised, or the RFID tag's flexible circuit substrate prevented the package from being opened. The other test made with no pre-slitting was AAMD-9. In this test, the package was a 5-year type, with a tear line comprised of stitching. The RFID tag failed, but the failure was likely due to the fact that slits were, in effect, punched in the RFID tag's flexible circuit substrate by the stitching process, and these slits or holes acted as rip propagation points. Generally, if no rip propagation points (holes or slits) exist, then it is necessary to use a backing material for the flexible circuit substrate that is weak enough to tear. Such a layer could, for example, be paper.

### TESTING

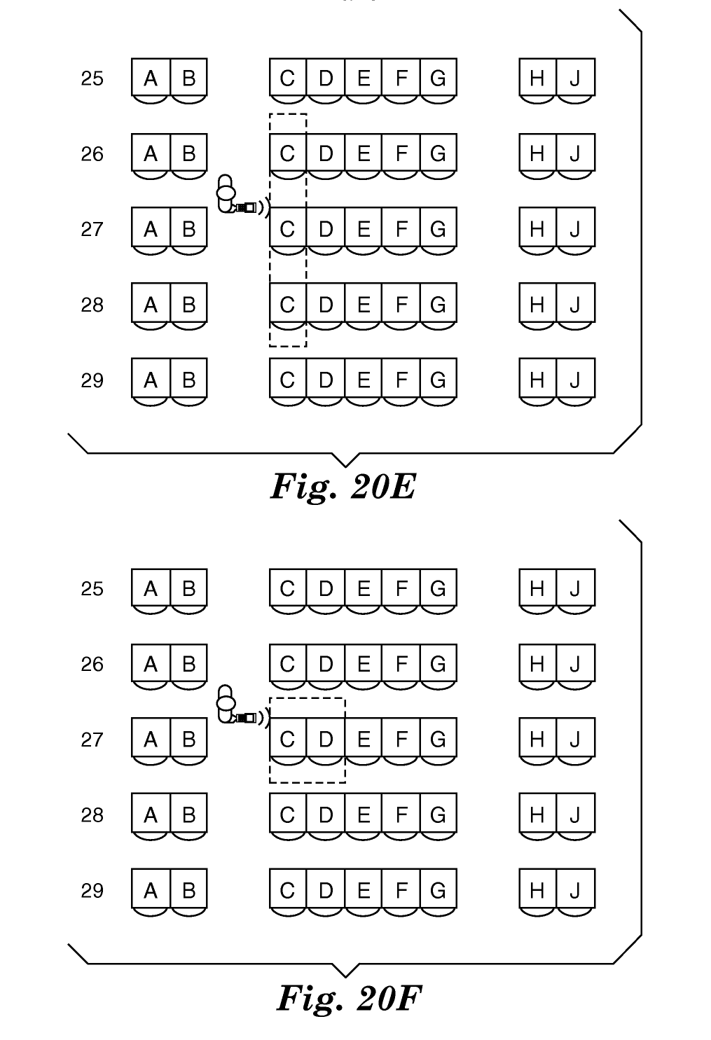

As mentioned earlier, RFID inspection methods were tested on a Boeing 737 and 747, a McDonnel-Douglas DC9 and 10, and an Airbus A300. RFID tags were placed between the underside of the seat bottom and the life vest for each seat in five contiguous rows within each aircraft. The impact of metal seat pans on interrogation using two transmit powers, 18 dBm and 19 dBm, was tested on a DC10 that did not initially have metal pans in its seats. A first set of interrogations was completed in this native state, then with installed metal plates under each seat cushion. FIG. 20A through FIG. 20H summarize aspects of the test methodology and results.

FIG. 20A is an exemplary user interface as might be displayed by an inspection device guiding a user inspecting the aircraft. The screen shows a graphical representation of the seating configuration of the aircraft being inspected. Particularly, numbered boxes represent seats, and form rows and aisles. The user interface, in this example, is an exemplary screenshot captured at the start of an inspection. Positional information regarding the inspection device, in this example, is garnered from an inspection protocol, which is presented to the user via the user interface. In other words, inspection device's display screen advises the user of the order in which to scan (“Press Trigger to Scan 25A,B.” After an inspection event has concluded, for example by the user pressing and releasing a trigger on an inspection device, instructions on the inspection device may then read, “Press Trigger to Scan 26A,B.”

FIG. 20B shows how testing of metal plates/radio transmit power on a DC10was executed. A user interrogated rows 20B1, and received signals back from seats 20B2, and moved per an interrogation event order specified by order 20B3. FIG. 20C is a key to assist in reading results of the testing, which is summarized in the table of FIG. 20D. FIG. 20D summarizes the absolute value read range for each interrogation event at transmit powers of 18 and 19 dBm, respectively. FIG. 20E is a graphic illustration of median read range achieved when metal pans are present under seats, using a radio transmit power of 18 dBm. FIG. 20F is a graphic illustration of median read range achieved when metal pans are not present under seats, using a radio transmit power of 18 dBm. FIG. 20G is a graphic illustration of median read range achieved when metal pans are present under seats, using a radio transmit power of 19 dBm. FIG. 20H is a graphic illustration of median read range achieved when metal pans are not present under seats, using a radio transmit power of 19 dBm.

Various implementations and embodiments of the invention have been described. For instance, methods of inspecting an aircraft, and supporting systems and graphic user interfaces have been described. Further, various configurations concerning the placement of an RFID tag on a life vest have been described, as have RFID tags placed on packaging and prepared in such a way that the life vest package is tamper evident. Nevertheless, it is understood that various modifications can be made without departing from the invention. Accordingly, these and other embodiments are within the scope of the following claims.

1. A method comprising:
storing, within a handheld radio frequency identification (RFID) inspection device, an aircraft profile that at least identifies expected locations of one or more life vests on an aircraft;
interrogating, with the handheld RFID inspection device, at least one RFID tag associated with a life vest on an aircraft; and,
reading, into the handheld RFID inspection device, RFID tag information from the interrogated RFID tag.

2. The method of claim 1, wherein the aircraft profile additionally identifies a life vest expiration data set, which defines the date at which time the life vest expires, or defines information from which the date at which time the life vest expires may be derived.

3. The method of claim 1, wherein the RFID tag information includes a life vest expiration data set, which defines the date at which time the life vest expires, or defines information from which the date at which time the life vest expires may be derived.

4. The method of claim 2, further comprising:
based on the RFID tag information or the profile, determining if some expected life vests are present on the aircraft, or if any of the life vests are expired or approaching expiration, or both.

5. The method of claim 1, wherein the aircraft profile further includes unique identifiers associated with at least some life vests expected to be on the aircraft.

6. The method of claim 5, wherein the aircraft profile further includes an association between at least some of the expected locations of a plurality of life vests and the unique identifiers of the life vests.

7. The method of 6, further comprising:
based on the RFID tag information and the information in the aircraft profile, automatically determining if expected life vests are present on the aircraft, or if any of the life vests are expired or approaching expiration, or both.

8. The method of claim 5, further comprising:
determining the location of the RFID tag inspection device, which defines a current location of the inspection device in the aircraft at a point in time during an aircraft inspection.

9. The method of claim 6, further comprising:
determining the location of the RFID tag inspection device, which defines a current location of the inspection device in the aircraft at a point in time during an aircraft inspection.

10. The method of claim 9, further comprising:
based on the RFID tag information, the information in the aircraft profile, and the location of the RFID tag inspection device, determining if expected life vests are present on the aircraft, or if any of the life vests are expired or approaching expiration, or both.

11. The method of claim 9, further comprising:
based on the RFID tag information, the information in the aircraft profile, and the location of the RFID tag inspection device, determining if any of the life vests' expected locations are inconsistent with the location of the RFID tag inspection device.

12. The method of claim 10, wherein determining the location of the RFID tag inspection device comprises using an inspection protocol, programmed into the RFID tag inspection device, which defines the order in which at least some areas of the airplane will be inspected.

13. The method of claim 12, wherein the inspection protocol is specified by a user.

14. The method of claim 12, wherein the inspection protocol is specified by the RFID tag inspection device.

15. The method of claim 9, wherein the location of the RFID tag inspection device is determined by interrogating a marker and reading information from the marker.

16. The method of claim 15, wherein the information from the marker comprises data defining a location on the aircraft.

17. The method of claim 15, wherein the information from the marker comprises a unique identifier, which is cross-referenced with a database on the RFID tag inspection device containing location information associated with unique identifiers of the marks.

18. The method of claim 15, wherein the marker is an RFID tag.

19. The method of claim 15, wherein the marker is a bar code.

20. The method of claim 10, wherein the location of the RFID tag inspection device is determined by the use of heuristic data analysis techniques.

21. A method comprising:
storing, with a handheld radio frequency identification (RFID) inspection device, an aircraft profile that includes a unique identifier for a plurality of life vests expected to be on an aircraft, wherein the aircraft profile further includes location identification data that defines expected locations of at least some of the life vests within the aircraft;
interrogating, with the handheld RFID inspection device, at least one of the RFID tags associated with the life vests on the airplane and receiving into the handheld RFID inspection device RFID tag information from the interrogated RFID tag; and
assigning a status to the life vest associated with the interrogated RFID tag, wherein the status indicates state information about the expected location of the life vest.

22. The method of claim 21, wherein RFID tag information includes a unique identifier.

23. The method of claim 22, further comprising:
using the unique identifier from the RFID tag to access the location identification data for at least one life vest and determine the expected location for the life vest associated with the interrogated RFID tag;

24. The method of claim 21, further comprising:
receiving, with the handheld RFID inspection device, input that defines a type of life vest inspection protocol to be performed on the aircraft, wherein the input is selected from a pre-defined set of life vest inspection protocols presented on a user interface of the RFID inspection device.

25. The method of claim 21, wherein the location identification data specifies a storage location or seat row and number at which point a life vest is expected to be located on the aircraft.

26. The method of claim 21 wherein state information about the expected life vest location indicates the presence of a life vest, the presence of an improper life vest, the absence of a life vest, or the presence of an expired or soon-to-be expired life vest.

27. The method of claim 21 wherein state information about the life vests expected to be on an aircraft indicates the expiration of the life vest.

28. A method for performing an inspection of life vests on an aircraft comprising:
storing, in a handheld radio frequency identification (RFID) inspection device, an aircraft profile that includes a unique identifier for a plurality of life vests expected to be on an aircraft, wherein the aircraft profile further includes expected location identification data that defines expected locations of at least some of the life vests within the aircraft;
determining inspection device location information, which defines a current location of the inspection device in the aircraft at a point in time during an aircraft inspection;
interrogating, with the handheld RFID inspection device, at least one of the RFID tags associated with the life vests on the airplane and receiving into the handheld RFID inspection device RFID tag information from the interrogated RFID tag;
using the RFID tag information to look up the location identification data for at least one life vest;
comparing the life vest's associated RFID tag expected location identification data against the inspection device location information; and
assigning, based on the comparison, a status to a location identification code member of a data set representing expected life vest locations for an aircraft, wherein the status indicates state information about the expected location of the life vest, or state information about the life vest.

29. The method of claim 28 wherein state information about the expected life vest location indicates the presence of a life vest, the presence of an improper life vest, the absence of a life vest, or the presence of an expired or soon-to-be expired life vest.

30. The method of claim 28 wherein state information about the life vest further comprises indication of the expiration of the life vest.

31. The method of claim 28, wherein determining inspection device location information comprises the use of an inspection protocol which defines the order in which at least some areas of the airplane will be inspected.

32. The method of claim 28, wherein determining inspection device location information comprises interrogating an RFID tag containing location information on it.

33. The method of claim 28, wherein determining inspection device location information comprises the use of heuristic data analysis techniques.

34. A method comprising:
interrogating RFID tags associated with a plurality of life vests on an airplane with a handheld RFID tag inspection device, and receiving into the handheld RFID inspection device at least an identifier from an RFID tag that defines the expected location of a life vest on an aircraft; and
associating a status to at least some of the expected locations of the aircraft, wherein the status indicates the state of an expected life vest location.

35. Method of claim 34, wherein state of an expected life vest location indicates the presence of a life vest, the presence of an improper life vest, the absence of a life vest, or the presence of an expired or soon-to-be expired life vest.

36. A method comprising:
interrogating, with a handheld RFID inspection device, at least one RFID tag associated with a life vest on an aircraft;
receiving, into the handheld RFID inspection device, RFID tag information from the interrogated RFID tag, wherein the RFID tag information contains life vest expiration data; and,
based on the RFID tag data, determining the expiration date of the life vest.

37. A method comprising:
interrogating, with a handheld RFID inspection device, at least one RFID tag associated with a life vest on an aircraft;
receiving, into the handheld RFID inspection device, RFID tag information from the interrogated RFID tag, where the RFID tag information defines the expected location of the associated life vest;
determining the location of the RFID tag inspection device, which defines a current location of the inspection device in the aircraft at a point in time during an aircraft inspection; and,
based on the expected location of the life vest read from the RFID tag, compared against the location of the RFID tag inspection device, determining if the life vest is not in its expected location.

38. A method comprising:
interrogating, with a wireless inspection device, a profile storage and retrieval system associated with a vehicle;
receiving vehicle profile information from the profile storage and retrieval system, said vehicle profile information defining at least one physical characteristic of the vehicle;
inspecting RFID-tagged items on the vehicle using the wireless inspection device, said inspection yielding inspection data; and,
analyzing the inspection data in light of the vehicle profile data; and,
based on the analysis, providing data to a user indicating at least one expected tagged item was located in its correct placement on the vehicle.

39. The method of claim 38, further comprising:
based on the analysis, providing data to a user indicating at least one expected tagged item was not located on the vehicle.

40. The method of claim 38, wherein the profile storage and retrieval system comprising one or more RFID tags.

41. The method of claim 40, wherein the vehicle is an aircraft.

42. The method of claim 41 wherein the vehicle profile information additionally includes at least one piece of information concerning an inspection protocol, said inspection protocol defining the process a user of the wireless inspection device may use to inspect the vehicle.

43. The method of claim 41, wherein the one piece of information concerning an inspection protocol is the point where an inspection should either commence or complete.

44. The method of claim 38, wherein the physical characteristics include the location of at least one seat.

45. The method of claim 38, wherein the physical characteristics include at least one storage location.
